(19) United States
(12) Patent Application Publication
(10) Pub. No.: US 2017/0029544 A1
(43) Pub. Date: Feb. 2, 2017

(54) PROCESS FOR THE EMULSION POLYMERIZATION OF FREE-RADICALLY POLYMERIZABLE, ETHYLENICALLY UNSATURATED MONOMERS

(71) Applicant: CELANESE SALES GERMANY GMBH, Sulzbach (Taunus) (DE)

(72) Inventors: Harmin MUELLER, Hofheim (DE); Stefan NOGAI, Heidelberg (DE); Alexander MADL, Berlin (DE); Harald PETRI, Aarbergen (DE); Elmar LINNEMANN, Frankfurt am Main (DE); Frank SCHUSTER, Eppstein (DE); Stephan KRIEGER, Hofheim (DE); Kerstin GOHR, Hochheim (DE)

(21) Appl. No.: 15/302,811

(22) PCT Filed: Apr. 8, 2015
(86) PCT No.: PCT/EP2015/057623

§ 371 Date: Oct. 7, 2016

(30) Foreign Application Priority Data
Apr. 9, 2014 (EP) 14164007.8

(51) Int. Cl. C08F 218/08; C08L 31/04

(52) U.S. Cl. CPC C08F 218/08; C08L 31/04; C08L 2201/50

(57) ABSTRACT

The present invention relates to a process for the emulsion polymerization of free-radically polymerizable, ethylenically unsaturated main monomers, and optionally further auxiliary monomers copolymerizable therewith, wherein the polymerization comprises a polymerization reaction phase starting with the first addition of an initiator or starting with the first addition of monomers, whatever is later, and ending with the completion of the addition of the initiator or the completion of the addition of total monomers, whatever is later, wherein the reaction temperature is increased during said polymerization reaction phase from a start temperature in the range of about 30° C. to about 85° C. to an end temperature in the range of about 60° C. to about 160° C., and wherein the polymerization temperature is increased for at least 25% of the duration of said polymerization reaction phase. The present invention further relates to an aqueous (co) polymer dispersion comprising at least one (co)polymer obtained by said process, and the use of this aqueous (co)polymer dispersion.

The present invention relates to a process for the emulsion polymerization of free-radically polymerizable, ethylenically unsaturated main monomers, and optionally further auxiliary monomers copolymerizable therewith, wherein the polymerization comprises a polymerization reaction phase starting with the first addition of an initiator or starting with the first addition of monomers, whatever is later, and ending with the completion of the addition of the initiator or the completion of the addition of total monomers, whatever is later, wherein the reaction temperature is increased during said polymerization reaction phase from a start temperature in the range of about 30° C. to about 85° C. to an end temperature in the range of about 60° C. to about 160° C., and wherein the polymerization temperature is increased for at least 25% of the duration of said polymerization reaction phase. The present invention further relates to an aqueous (co)polymer dispersion comprising at least one (co)polymer obtained by said process, and the use of this aqueous (co)polymer dispersion.

Polymer dispersions are well known as binders in the production of coating compositions such as plasters, renders, adhesives, paints, carpet back coatings, coatings for paper, coatings for engineered fabrics, etc., and are manufactured commercially in high amounts. Advantages of using water borne systems for paints include low cost, ease of application and cleanup, reduced drying times, and low or no odor or emissions of volatile organic compounds (VOC).

In the majority of cases such systems are prepared by means of emulsion polymerization, generally in the form of a continuous, batch or semi-batch process. A batch process refers to a discontinuous, charge wise polymerization reaction, whereas a semi-batch process refers to a combination of batch and continuous mode, in which part of the monomer is slowly added in the course of the polymerization reaction.

An important aspect in the production of polymer dispersions is the efficiency of the production, and it is advantageous for commercial reasons that the production time for the polymer dispersion is as short as possible.

One particular problem, however, is the removal of the heat of reaction during the exothermic polymerization, although this heterophase mixture typically contains between about 30% and about 60% water. The removal of heat is often the limiting factor in performing the polymerization more rapidly in order to improve space-time yields.

It is furthermore required that the obtained polymer dispersions are highly reproducible and show a good performance with respect to the application properties, for instance expressed by a specifically defined average molecular weight, molecular weight distribution or viscosity. In the case of free-radical emulsion polymerization, the operation can be controlled via a multiplicity of process parameters, such as polymerization temperature, reactant metering rate, removal of heat of reaction, nature and amount of components of the reaction system, or design of the polymerization reactor.

Generally, high polymerization temperatures enable shorter polymerization times, but may lead to products having a deteriorated performance, whereas lower polymerization temperatures may require longer polymerization times, but may lead to products with improved properties. Accordingly, it is generally difficult to reduce polymerization times while maintaining good application properties of the obtained polymers by increasing polymerization temperature. The prior art describes different approaches to solve the above problem in free-radical polymerization.

One approach is the removal of the reaction heat based on the use of additional internal coolers or heat exchangers. For example, JP-A-07/082304 describes the suspension polymerization of vinyl chloride in a reactor equipped with reflux condenser. To shorten the polymerization time, a highly active, oil-soluble initiator is added to the reaction mixture before 60% of the total conversion is reached.

WO-A-2005/016977 discloses a process for preparing aqueous polymer dispersions by means of free-radically initiated emulsion polymerization. This process encompasses the one-stage polymerization of at least one ethylenically unsaturated compound in the presence of at least one dispersant and of at least one water-soluble and one oil-soluble free-radical initiator. According to WO-A-2005/016977, the combined use of a water-soluble and an oil-soluble free-radical initiator allows the production of aqueous polymer dispersions having a low residual monomer content, thus avoiding the necessity of a separate post-polymerization treatment.

EP 2 088 162 A1 discloses a process for the emulsion polymerization of free-radically polymerizable ethylenically unsaturated monomers at higher temperatures, namely in the range of 100° C. to 160° C., wherein the emulsion polymerization is performed in the presence of emulsifiers.

However, the above-described processes generally have the disadvantage that the polymerization reaction is performed at higher reaction temperatures which very often impairs product properties, such as the reduction of the molecular weight in the case of polymers, the reduction of wet scrub resistance in the case of paints, or the reduction of heat resistance in the case of adhesives, for example. The main problem here is always that measures for heat removal must be commercially viable, while not impairing product properties compared to products which have been prepared at lower temperatures.

Accordingly, the technical problem underlying the present invention is the provision of an improved process for the emulsion polymerization which is faster compared to conventional emulsion polymerization processes at low temperatures and which, at the same time, leads to products with the desired molecular weights and with a good performance with respect to the application properties. In addition, another technical problem underlying the present invention is the provision of an improved process for the emulsion polymerization which leads to products with a superior performance with respect to the application properties while requiring polymerization times comparable to those of conventional emulsion polymerization processes.

According to the present invention, these technical problems are solved by the provision of a process for the emulsion polymerization of free-radically polymerizable, ethylenically unsaturated main monomers, and optionally further auxiliary monomers copolymerizable therewith, wherein the polymerization comprises a polymerization reaction phase starting with the first addition of an initiator or starting with the first addition of monomers, whatever is later, and ending with the completion of the addition of the initiator or the completion of the addition of total monomers, whatever is later, wherein the reaction temperature is increased during said polymerization reaction phase from a start temperature in the range of about 30° C. to about 85° C. to an end temperature in the range of about 60° C. to about 160° C., and wherein the polymerization temperature is increased for at least 25% of the duration of said polymerization reaction phase.

### Temperature Profile

According to the present invention, the monomers are polymerized by an emulsion polymerization process, wherein the reaction temperature is increased during a specifically defined polymerization reaction phase from a start temperature in the range of about 30° C. to about 85° C. to an end temperature in the range of about 60° C. to about 160° C.

It was surprisingly found that by employing the process of the present invention, it is possible to perform the polymerization more rapidly, thus improving space-time yields, while, at the same time, obtaining products with the desired molecular weights and with a good performance with respect to the application properties. In addition, it is possible to obtain products with a superior performance with respect to the application properties while requiring polymerization times comparable to those of conventional emulsion polymerization processes. According to the present invention, this is achieved by starting at lower polymerization temperatures and then increasing the polymerization temperature in the course of the polymerization reaction. Accordingly, a feature of the process of the invention in comparison to conventional low-temperature processes of emulsion polymerization are significantly reduced polymerization times, or improved application properties when applying conventional polymerization times.

Within the meaning of the present invention, the term “polymerization reaction phase” refers to a phase which starts with the first addition of an initiator or with the first addition of monomers, whatever is later. Accordingly, the polymerization reaction phase only starts when both components, monomer and initiator, are present. Suitable initiators for radical polymerization reactions include, for example, thermal initiators, photochemical initiators and redox initiator systems. When a redox initiator system is used, the first addition of an initiator refers to the addition of the second component of the redox initiator system (the oxidant and/or the reducing agent), since radicals are only formed if both components are present. It is noted that the above-defined start of the “polymerization reaction phase” does not necessarily coincide with the actual start of the polymerization reaction which depends on the formation of initiating radicals. For example, when using a thermal initiator, the polymerization reaction does not start before the decomposition temperature of the thermal initiator has been reached, even though initiator and monomer are present. The actual start of the polymerization reaction can be determined, for example, by the identification of radicals in the reaction mixture (for example by means of ESR spectroscopy) or by the occurrence of polymerization reaction heat.

Generally for most emulsion polymerization processes (especially for commercial processes) it is favored that the time span between the start of the “polymerization reaction phase” (as defined above) and the actual start of the polymerization reaction is as short as possible.

The above defined polymerization reaction phase ends with the completion of the addition of the initiator or the completion of the addition of total monomers (i.e. main monomers and auxiliary monomers), whatever is later.

The claimed process for the emulsion polymerization may include an optional post-heating subsequent to the polymerization reaction phase in order to complete the polymerization reaction. According to a preferred embodiment of the present invention, post-heating is carried out for at least 15 minutes at a temperature of at least 85° C. According to a particularly preferred embodiment, post-heating is carried out for about 15 to about 60 minutes, at a temperature of at least 90° C. The claimed process for the emulsion polymerization generally ends, for example after the optional post-heating, after a polymerization of up to 98% of the monomers, based on the total weight, preferably after up to 99% of the monomers, based on the total weight, particularly preferably after up to 99.5% of the monomers, based on the total weight. In other words, the claimed process for the emulsion polymerization is finished or is considered to be finished when up to 98% by weight, based on total monomers, have been polymerized, preferably when up to 99% by weight, based on total monomers, have been polymerized, particularly preferably when up to 99.5% by weight, based on total monomers, have been polymerized.

Thus, the claimed process for the emulsion polymerization is to be distinguished from an optional post-polymerization reaction for removing residual monomers (being preferably performed in a different reactor), even though additional initiator might be added for such a post-polymerization. The person skilled in the art can dearly distinguish the actual polymerization reaction from such an optional post-polymerization reaction. The residual monomers generally account for not more than about 2% by weight, based on the total monomers, preferably not more than about 1% by weight, particularly preferably not more than about 0.5% by weight, based on the total monomers. Accordingly, a post-polymerization reaction may optionally take place subsequently to the claimed process for the emulsion polymerization wherein the post-polymerization reaction starts after up to 98% by weight, based on total monomers, have been polymerized, preferably after up to 99% by weight, based on total monomers, have been polymerized, particularly preferably after up to 99.5% by weight, based on total monomers, have been polymerized.

According to the present invention, the duration of the polymerization reaction phase is preferably at most 5 hours, more preferably less than 3.5 hours, and even more preferably less than 2 hour.

Furthermore, according to the present invention, the term “start temperature” refers to the temperature at the start of the polymerization reaction phase. The “end temperature” is defined as the temperature at the end of the polymerization reaction phase.

The start temperature is in a range of about 30° C. to about 85° C. In a preferred embodiment of the present invention, the start temperature is in range of about 40° C. to about 80° C. In a particularly preferred embodiment, the start temperature is in a range of about 55° C. to about 70° C. The end temperature is in a range of about 60° C. to about 160° C., preferably in a range of about 80° C. to about 120° C. In a particularly preferred embodiment, the end temperature is in a range of about 85° C. to about 110° C., in another particularly preferred embodiment, the end temperature is in a range of about 105° C. to about 120° C.

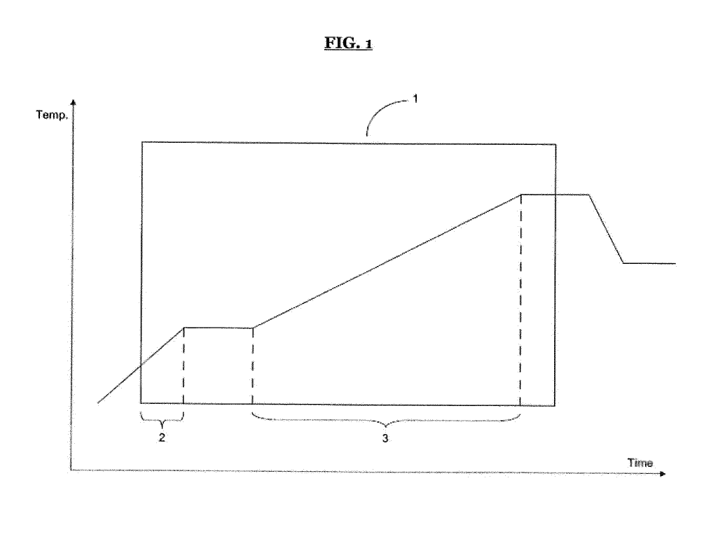

The polymerization reaction according to the present invention is exemplified by the temperature profile shown in FIG. 1. This figure shows the polymerization reaction phase of a polymerization reaction in the form of rectangle (1). The start of this polymerization reaction phase is defined by the first addition of initiator or the first addition of monomer, whatever is later. The end of the polymerization reaction phase is defined by the completion of the addition of initiator or the completion of the addition of monomer, whatever is later. The example of a polymerization reaction phase shown in FIG. 1 contains a period with a first temperature increase (2) and a period with a second temperature increase (3).

The increase of the reaction temperature can follow any suitable temperature profile where the end temperature is higher than the start temperature. Preferably, the temperature is increased continuously or semi-continuously. In a particularly preferred embodiment, the temperature is increased continuously.

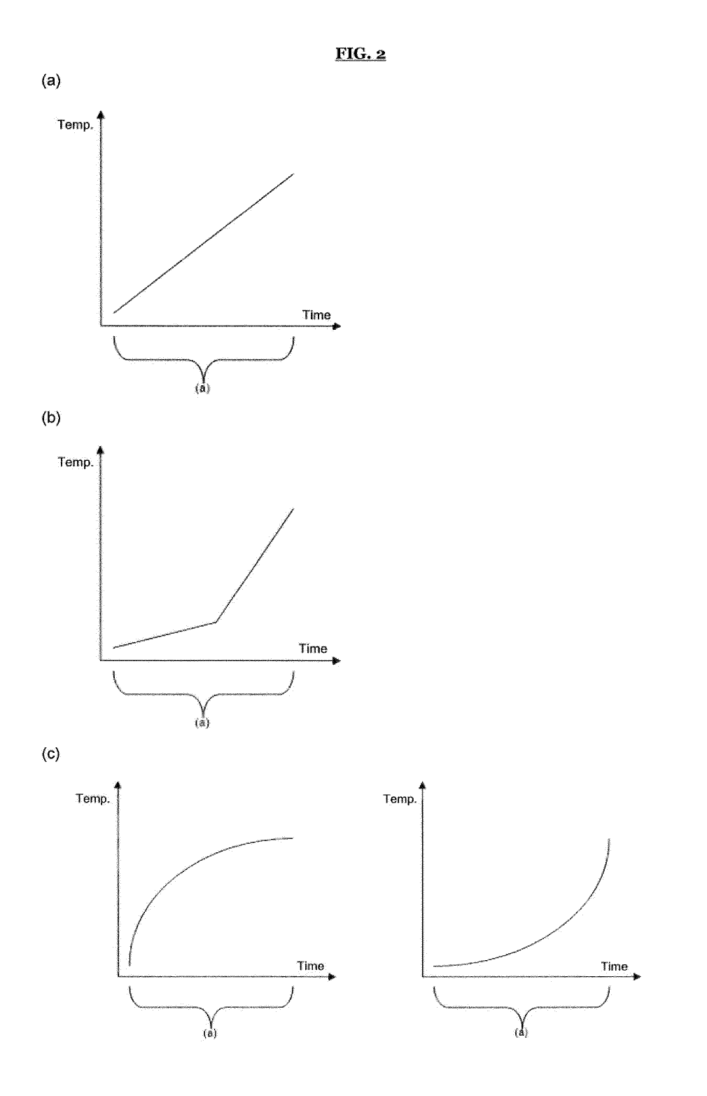

The term “continuous increase” refers to a continuous (in a mathematical sense) increase of the temperature over the time, i.e. the graph is a single unbroken curve with no “holes” or “jumps”. Examples for a continuous increase of the reaction temperature are shown in FIG. 2 and include

(a) a linear increase of the reaction temperature with a constant slope,
(b) a linear increase of the reaction temperature with two or more different slopes, and
(c) a non-linear increase of the reaction temperature.

The semi-continuous increase of the reaction temperature includes all suitable temperature profiles where the temperature is increased over the time, but where at least two polymerization reaction periods with increasing temperatures are separated by a polymerization reaction period without increasing temperature.

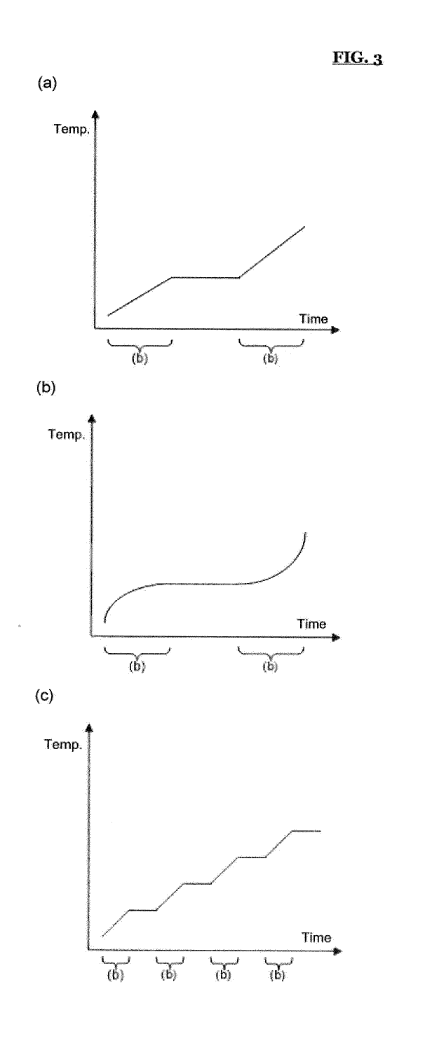

Examples for a semi-continuous increase of the reaction temperature are shown in FIG. 3 and include temperature profiles with at least two reaction periods of a linear or non-linear temperature increase having the same or different slopes, wherein the at least two reaction periods are separated by a reaction period of constant temperature (see FIGS. 3a and 3b). Accordingly, a semi-continuous increase also comprises a step-wise increase of the reaction temperature including, for example, at least two steps of temperature increase, at least three steps of temperature increase or at least four steps of temperature increase or at least five steps of temperature increase. According to a particularly preferred embodiment, a semi-continuous increase comprises a step-wise increase of the reaction temperature including at least ten steps of temperature increase or at least fifteen steps of temperature increase. FIG. 3c exemplarily shows such a step-wise temperature increase including four steps of temperature increase. According to the present invention, a step-wise increase of the reaction temperature including at least 20 steps of temperature increase is defined as a continuous temperature increase.

The temperature rate during the temperature increase is preferably in the range of about 0.01° C./min to about 10° C./min. In a more preferred embodiment, the temperature rate is in the range of about 0.05° C./min to about 5° C./min. In a particular preferred embodiment, the temperature rate is in the range of about 0.2° C./min to about 3° C./min. It is noted that the temperature rate does not need to be constant. It is also possible that different phases of the polymerization reaction have different temperature rates. In a particularly preferred embodiment of the present invention, the temperature increase comprises a period with a temperature rate of more than 0.05° C./min and less than 0.2° C./min, and a subsequent period with a temperature rate of 0.2° C./min to 0.7° C./min, and wherein at least 75% of the total monomers, based on the total weight, are added during the temperature increase in the course of said polymerization reaction phase.

The reaction temperature can be increased already with the start of the polymerization reaction phase. Alternatively, it is possible that the reaction temperature is initially kept constant after the start of the polymerization reaction phase, and the temperature increase is then started, for example, within the first 75% of the duration of the polymerization reaction phase, preferably within the first 50% of the duration of the polymerization reaction phase, particularly preferable within the first 30% of the duration polymerization reaction phase.

### Duration of the Temperature Increase

The polymerization temperature is increased for at least 25% of the duration of the polymerization reaction phase. This means that the polymerization temperature is increased during said polymerization reaction phase during at least 25% of the duration of said polymerization reaction phase. According to a preferred embodiment of the present invention, the polymerization temperature is increased for at least 50% of the duration of the polymerization reaction phase, more preferably for at least 60%. According to a particularly preferred embodiment of the present invention, the polymerization temperature is increased for at least 70% of the duration of the polymerization reaction phase.

When turning again to FIG. 1, it can be seen that the shown polymerization reaction phase (1) contains two periods (2) and (3) of temperature increase. According to the present invention, the sum of the durations of these two periods (2) and (3) accounts for at least 25% of the duration of the polymerization reaction phase (1).

The duration of the temperature increase in case of a continuous increase is denoted with (a) in FIG. 2. In the case of a semi-continuous increase of the reaction temperature, the duration of the increase of the reaction temperature only refers to the sum of the durations of those reaction periods where the temperature is increased (denoted with (b) in FIG. 3).

By this essential feature it is possible to attain the advantageous effects of the inventive process, namely to reduce polymerization time, while, at the same time, obtaining products with a good performance with respect to the application properties. In addition, it is also possible to obtain products with an improved performance when keeping the polymerization time constant.

### Addition of Monomers

According to a preferred embodiment of the present invention, at least 25% of the total monomers (i.e. main monomers and auxiliary monomers), based on the total weight, are added during the temperature increase in the course of said polymerization reaction phase. According to a more preferred embodiment, at least 40% of the total monomers, even more preferred at least 65% of total monomers, based on the total weight, are added during the temperature increase in the course of said polymerization reaction phase. In a particularly preferred embodiment, at least 75% of the total monomers, based on the total weight, are added during the temperature increase in the course of said polymerization reaction phase.

Assuming that the polymerization reaction is carried out under starving conditions, the monomers added in the course of the polymerization reaction phase basically instantaneously react and are converted into the respective (co)polymer. Consequently, according to a preferred embodiment, at least 25% of the total monomers (i.e. main monomers and auxiliary monomers), based on the total weight, are polymerized/converted in the course of the temperature increase, more preferably at least 40%, even more preferably at least 65%, and particularly preferably at least 75% of the total monomers, based on the total weight. Accordingly, the conversion of the monomers can be calculated from the amounts of monomers added in the course of the polymerization reaction. Alternatively, the total conversion can be determined, for example, by taking samples from the reaction mixture in appropriate intervals and analyzing the samples by known methods.

### Monomers

The present invention relates to a process for the emulsion polymerization of free-radically polymerizable, ethylenically unsaturated main monomers, and optionally further auxiliary monomers copolymerizable therewith. When polymerizing only one monomer, a homo-polymer is obtained by the inventive process. When polymerizing at least two monomers, a copolymer is obtained by the inventive process. In a preferred embodiment of the claimed process, at least two monomers are polymerized to obtain a copolymer.

### The Main Monomers

The main monomers generally form the principal monomers and preferably account for at least 50% by weight, more preferably for at least about 75% of the total monomers to be polymerized.

The free-radically polymerizable, ethylenically unsaturated main monomers encompass all possible ethylenically unsaturated monomers which are polymerizable by means of free radical polymerization.

The free-radically polymerizable, ethylenically unsaturated monomers are preferably selected from the group consisting of vinyl esters of C₁-C₁₈ alkanoic acids, vinyl esters of aromatic acids, vinyl aromatics, vinyl halogenides, α-olefins, dienes, monoesters and diesters of ethylenically unsaturated monocarboxylic or dicarboxylic acids with alkanols, and combinations thereof. According to one embodiment of the present invention, the combination of styrene and 1,3-butadiene is excluded from the possible combinations of the above-mentioned free-radically polymerizable, ethylenically unsaturated monomers.

Suitable vinyl esters include, for example, vinyl esters of straight-chain or branched carboxylic acids with 1 to 18 carbon atoms and vinyl esters of aromatic acids, such as vinyl formate, vinyl acetate, vinyl propionate, vinyl butyrate, vinyl isobutyrate, vinyl pivalate, 1-methylvinyl acetate, vinyl 2-ethylhexanoate, vinyl laurate, vinyl palmitate, vinyl myristate, vinyl stearate, vinyl ester of an α-branched carboxylic acid having 5 to 11 carbon atoms, especially vinyl esters of Versatic acid having 9 to 11 carbon atoms (i.e., VeoVa9™, VeoVa10™, VeoVa11™), vinyl benzoate, 4-tert-butyl vinyl benzoate, and combinations thereof. Vinyl acetate, vinyl laurate and the vinyl esters of Versatic acid having 9 to 11 carbon atoms (i.e., VeoVa9™, VeoVa10™, VeoVa11™) are particularly preferred.

Examples of suitable monomers of vinyl aromatics include styrene, vinyl toluene, and α-methyl styrene. Styrene is particularly preferred.

Suitable vinyl halogenides include vinyl fluoride, vinylidene fluoride, vinyl chloride, vinylidene chloride, and vinyl bromide. Vinyl chloride is particularly preferred.

Suitable α-olefins or diene monomers preferably have from 2 to 6 carbon atoms, and may include ethylene, propylene, isopropylene, n-butene, n-pentene, 1,3-butadiene, and isoprene. Ethylene is particularly preferred.

Suitable esters of ethylenically unsaturated monocarboxylic acids with alkanols include, for example, esters of acrylic acid, methacrylic acid and crotonic acid. Preferred esters of ethylenically unsaturated monocarboxylic acids include alkyl(meth)acrylates (i.e. alkyl esters of acrylic acid or alkyl esters of methacrylic acid). Examples of these are methyl acrylate, ethyl acrylate, n-propyl acrylate, iso-propyl acrylate, n-butyl acrylate, tert-butyl acrylate, iso-butyl acrylate, 2-ethylhexyl acrylate, cyclohexyl acrylate, norbornyl acrylate, methyl methacrylate, ethyl methacrylate, n-propyl methacrylate, iso-propyl methacrylate, n-butyl methacrylate, tert-butyl methacrylate, iso-butyl methacrylate, 2-ethylhexyl methacrylate, cyclohexyl methacrylate, and norbornyl methacrylate. These esters can be used alone or in the form of a combination of two or more esters. Methyl acrylate, methyl methacrylate and 2-ethylhexyl acrylate are particularly preferred.

Examples of suitable monoesters and diesters of ethylenically unsaturated dicarboxylic acids with alkanols include the monoesters and diesters of fumaric acid, maleic acid and itaconic acid such as the diethyl and diisopropyl esters, in particular dibutyl maleate, dioctyl maleate, monooctyl maleate, and maleic anhydride.

### Preferred Copolymers

The above monomers can be used alone or in combination in order to form the respective homo- or copolymers. Preferred homopolymers are vinyl acetate polymer and methyl methacylate and acrylatepolymers. However, the use of a combination of monomers is preferred in order to form one of the following copolymers:

(1) According to a preferred embodiment of the present invention, a vinyl ester-ethylene copolymer is formed, such as a vinyl acetate-ethylene copolymer, which, optionally, comprises one or more further monomers selected from the group consisting of vinyl chloride, a further vinyl ester, a diester of an ethylenically unsaturated dicarboxylic acid with alkanols, and combinations thereof. The further vinyl ester is preferably selected from the group consisting of vinyl propionate, vinyl laurate, vinyl pivalate, vinyl 2-ethylhexanoate, and vinyl esters of an α-branched carboxylic acid having 5 to 11 carbon atoms, especially vinyl esters of Versatic acid having 9 to 11 carbon atoms (i.e., VeoVa9™, VeoVa10™, VeoVa11™), and combinations thereof. The diester of an ethylenically unsaturated dicarboxylic acid with alkanols is preferably selected from dibutyl maleate or dioctyl maleate.

In a particularly preferred embodiment, a copolymer of vinyl acetate and ethylene is formed wherein the copolymer contains 1% to 40%, more preferably 5% to 28% by weight of ethylene, based on the total amount of monomers. When additionally vinyl chloride, a further vinyl ester, or a diester of an ethylenically unsaturated dicarboxylic acid with alkanols is employed, these components may be contained in an amount of from 1 to 60% by weight, based on the total amount of monomers. For example, the copolymer may be a copolymer of vinyl acetate, 1% to 40% by weight of ethylene, and 1% to 60% by weight of vinyl chloride, based on the total amount of monomers. According to another example, the copolymer may be a copolymer of vinyl acetate, 1% to 40% by weight of ethylene, and IA to 60% by weight of a vinyl ester of Versatic acid having 9 to 11 carbon atoms, based on the total amount of monomers.

(2) According to another preferred embodiment of the present invention, a copolymer of vinyl acetate and at least one further monomer, selected from the group consisting of ethylene, vinyl chloride, a further vinyl ester, an acrylate, a methacrylate, a diester of an ethylenically unsaturated dicarboxylic acid with alkanols, and combinations thereof, is formed. The further vinyl ester is preferably selected from the group consisting of vinyl propionate, vinyl laurate, vinyl pivalate, vinyl 2-ethylhexanoate, and vinyl esters of an α-branched carboxylic acid having 5 to 11 carbon atoms, especially vinyl esters of Versatic acid having 9 to 11 carbon atoms (i.e., VeoVa9™, VeoVa10™, VeoVa11™), and combinations thereof. The acrylate or methacrylate is preferably selected from the group consisting of methyl methacrylate, methyl acrylate, butyl acrylate, where the butyl acrylate used may be n-, iso- or tert-butyl acrylate, and 2-ethylhexyl acrylate, and combinations thereof. The diester of an ethylenically unsaturated dicarboxylic acid with alkanols is preferably selected from dibutyl maleate or dioctyl maleate. The at least one further monomer is preferably contained in an amount of 1 to 40% by weight, based on the total amount of monomers.

In a particularly preferred embodiment, a copolymer of 30% to 75% by weight of vinyl acetate, 1% to 30% by weight of vinyl laurate or a vinyl ester of Versatic acid having 9 to 11 carbon atoms, 1% to 30% by weight of n-butyl acrylate or 2-ethylhexyl acrylate, and IA to 40% by weight of ethylene, based on the total amount of monomers, is formed.

(3) According to another embodiment of the present invention, a vinyl ester-acrylate copolymer, optionally further containing ethylene, or a vinyl ester-methacrylate copolymer, optionally further containing ethylene, is formed. The vinyl ester may be selected from the group consisting of vinyl acetate, vinyl propionate, vinyl laurate, vinyl pivalate, vinyl 2-ethylhexanoate, and vinyl esters of an α-branched carboxylic acid having 5 to 11 carbon atoms, especially vinyl esters of Versatic acid having 9 to 11 carbon atoms (i.e., VeoVa9™, VeoVa10™, VeoVa11™), and combinations thereof. The acrylate or methacrylate may be selected from the group consisting of methyl methacrylate, methyl acrylate, butyl acrylate, where the butyl acrylate used may be n-, iso- or tert-butyl acrylate, and 2-ethylhexyl acrylate, and combinations thereof.

For example, a copolymer of vinyl acetate, 1% to 60% by weight of n-butyl acrylate or 2-ethylhexyl acrylate, and optionally 1% to 40% by weight of ethylene, is formed.

(4) According to another embodiment of the present invention, an acrylate or methacrylate copolymer, optionally further containing 1,3-butadiene or styrene, is formed. The acrylate or methacrylate may be selected from the group consisting of methyl methacrylate, methyl acrylate, butyl acrylate, where the butyl acrylate used may be n-, iso- or tert-butyl acrylate, and 2-ethylhexyl acrylate, and combinations thereof.

For example, a copolymer of methyl methacrylate and 2-ethylhexyl acrylate, or a copolymer of methyl methacrylate and 1,3-butadiene, or a copolymer of styrene and butyl acrylate, or a copolymer of styrene and methyl methacrylate and butyl acrylate, or a copolymer of styrene and 2-ethylhexyl acrylate is formed.

According to the present invention, the most preferred copolymers are selected from the group consisting of vinyl ester-ethylene copolymers such as vinyl acetate-ethylene copolymers, and copolymers of vinyl acetate and ethylene and a vinyl ester of Versatic acid having 9 to 11 carbon atoms (i.e., VeoVa9™, VeoVa10™, VeoVa11™).

### The Auxiliary Monomers

The above-mentioned monomers forming homo- or copolymers only represent the main monomers. In addition, suitable auxiliary monomers can be copolymerized with the main monomers. Accordingly, it is possible to use further auxiliary comonomers, in addition to the above-described main monomers, which modify the polymer properties in a specific way. Such auxiliary monomers are preferably copolymerized in amounts, based on the total monomers to be polymerized, of less than 20% by weight, more preferably in the range of about 0.01% to about 15%, and even more preferably in the range of about 0.1 to about 10% by weight.

The auxiliary monomers are preferably selected from the group consisting of ethylenically unsaturated mono- and dicarboxylic acids, ethylenically unsaturated sulfonic acids or their salts, ethylenically unsaturated carboxylic acid amides and nitriles, ethylenically unsaturated phosphonic acids or their salts, ethylenically unsaturated ethylene urea derivatives, ethylenically unsaturated 1,3-dicarbonyl compounds, ethylenically unsaturated hydroxyl group or epoxy group containing monomers, ethylenically unsaturated silane compounds, and combinations thereof.

In addition, the composition may comprise precrosslinking monomers such as polyethylenically unsaturated comonomers, examples being divinyl adipate, diallyl maleate, diallyl phthalate, 034 methacrylate, butanediol diacrylate, and triallyl cyanurate, or postcrosslinking comonomers, examples being acrylamidoglycolic acid (AGA), methylacrylamidoglycolic acid methyl ester (MAGME), N-methylolacrylamide (NMA), N-methylolmethacrylamide, N-methylolallyl carbamate, alkyl ethers and esters such as the isobutoxy ethers or esters of N-methylolacrylamide, of N-methylolmethacrylamide, and of N-methylolallyl carbamate.

Examples of suitable ethylenically unsaturated mono- and dicarboxylic acids include acrylic acid, methacrylic acid, crotonic acid, maleic acid, itaconic acid, citraconic acid and fumaric acid. Suitable ethylenically unsaturated sulfonic acids or their salts include, for example, vinylsulfonic acid, 2-acrylamido-2-methyl propane sulfonic acid (AMPS), 2-acryloyloxy and 2-methacryloyloxyethane sulfonic acid, 3-acryloyloxy- and 3-methacryloyloxypropane sulfonic acid and vinylbenzene sulfonic acid. Examples of ethylenically unsaturated phosphonic acids or their salts include vinylphosphonic acid. In addition to said acids, it is also possible to use the salts thereof, preferably alkali metal salts thereof or ammonium salts thereof and in particular sodium salts thereof, such as the sodium salts of vinylsulfonic acid or 2-acrylamidopropane sulfonic acid. The use of the sodium salt of vinylsulfonic acid is particularly preferred.

Suitable ethylenically unsaturated carboxylic acid amides and carboxylic acid nitriles include, for example, acrylonitrile, acryl amide, methacryl amide, diacetone acrylamide, croton amide, the mono- or diamide of fumaric acid, the mono- or diamide of maleic acid, the mono- or diamide of itaconic acid and the mono- or diamide of citraconic acid. In addition to the amides, it is also possible to use the N-functionalized derivatives thereof, such as the N-alkyl or N,N-dialkylamides.

Suitable ethylenically unsaturated ethylene urea derivatives include, for example, N-vinyl and N-allylurea and derivatives of imidazolin-2-one, such as N-vinyl and N-allylimidazolidin-2-one, N-vinyloxyethylimidazolidin-2-one, N-(2-(meth)acrylamidoethyl)imidazolidin-2-one, N-(2-(meth)acryloxyethyl)imidazolidin-2-one and N-(2-(meth)acryloxyacetamidoethyl) imidazolidin-2-one. Other derivatives of urea or imidazolidin-2-one may also be used.

Suitable ethylenically unsaturated 1,3-dicarbonyl compounds include, for example, acetylacetoxy group containing monomers such as allyl acetoacetate, vinyl acetoacetate, acetoacetoxyethyl acrylate, acetoacetoxyethyl methacrylate, acetoacetoxypropyl methacrylate, 2,3-di(acetoacetoxy)propyl methacrylate and acetoacetoxybutyl methacrylate.

Suitable ethylenically unsaturated hydroxyl group or epoxy group containing monomers include, for example, hydroxyethyl methacrylate, glycidyl acrylate, glycidyl methacrylate, allyl glycidyl ether, vinyl glycidyl ether, hydroxypropyl acrylate, hydroxybutyl acrylate, hydroxyethyl acrylate, hydroxypropyl methacrylate, vinylcyclohexene oxide, limonene oxide, myrcene oxide, caryophyllene oxide, vinyltoluenes and styrenes substituted with a glycidyl radical in the aromatic moiety, and vinylbenzoates substituted with a glycidyl radical in the aromatic moiety. Preferably, the ethylenically unsaturated hydroxyl group or epoxy group containing monomers are selected from the group consisting of hydroxyethyl methacrylate, glycidyl acrylate, glycidyl methacrylate, allyl glycidyl ether, vinyl glycidyl ether, hydroxypropyl acrylate, hydroxybutyl acrylate, hydroxyethyl acrylate, hydroxypropyl methacrylate, and combinations thereof.

Examples of ethylenically unsaturated silane compounds include ethylenically unsaturated silicon compounds of the general formula R¹SiR₀₋₂(OR²)₁₋₃, where the number of R and OR² moieties is such that the silicon is tetravalent, where R is a C₁ to C₃ alkyl radical, C₁ to C₃ alkoxy radical or halogen (e.g., Cl or Br), R¹ is CH₂CR³(CH₂)₀₋₁ or CH₂CR³CO₂(CH₂)₁₋₃, R² is an unbranched or branched, unsubstituted or substituted alkyl radical having 1 to 12 carbon atoms, preferably 1 to 3 carbon atoms, or is an acyl radical having 2 to 12 carbon atoms, it being possible for R² to be interrupted, if desired, by an ether group, and R³ is H or CH₃. Preferably, the ethylenically unsaturated silane compounds is selected from the group consisting of γ-acryl- and γ-methacryloxypropyl tri(alkoxy)silanes, γ-methacryloxymethyl tri(alkoxy)silanes, γ-methacryloxypropylmethyl di(alkoxy)silanes, vinylalkyl di(alkoxy)silanes and vinyl tri(alkoxy)silanes, where the alkoxy groups used may, for example, be methoxy, ethoxy, methoxyethylene, ethoxyethylene, methoxypropylene glycol ether or ethoxypropylene glycol ether radicals. Examples of suitable ethylenically unsaturated silane compounds include vinyl trimethoxysilane, vinyl triethoxysilane, vinyl tripropoxysilane, vinyl triisopropoxysilane, vinyl tris-(1-methoxy) isopropoxysilane, vinyl tributoxysilane, vinyl triacetoxysilane, 3-methacryloxypropyl trimethoxysilane, 3-methacryloxypropylmethyl dimethoxysilane, methacryloxymethyl trimethoxysilane, 3-methacryloxypropyl tris(2-methoxyethoxy)silane, vinyl trichlorosilane, vinyl methyldichlorosilane, vinyltris(2-methoxyethoxy)silane, trisacetoxyvinylsilane. According to a preferred embodiment of the present invention, the auxiliary monomer contains a silane compound selected from the group consisting of vinyl trimethoxysilane, vinyl triethoxysilane, vinyl tris-(1-methoxy) isopropoxy silane, methacryloxypropyl tris(2-methoxyethoxy)silane, 3-methacryloxypropyl trimethoxysilane, 3-methacryloxypropylmethyl dimethoxysilane, 3-methacryloxymethyl trimethoxysilane, and combinations thereof. Further suitable ethylenically unsaturated silane compounds include silane oligomers comprising, for example, vinyl functionalities, such as SILQUEST® RC-1 or SILQUEST® VX-193.

According to the present invention, the most preferred auxiliary monomers are selected from the group consisting of acrylic acid, methacrylic acid, itaconic acid, the sodium salt of vinylsulfonic acid, diallyl phthalate, vinyl trimethoxysilane, vinyl triethoxysilane, 3-methacryloxypropyl trimethoxysilane, glycidyl acrylate and glycidyl methacrylate. It is particularly preferred to use an ethylenically unsaturated silane monomer or an ethylenically unsaturated mono- or dicarboxylic acid in combination with an ethylenically unsaturated epoxy group containing monomer. Most preferably, 0.5 to 2.0%, based on total monomers, glycidyl methacrylate is used in combination with 0.05 to 1.5%, based on total monomers, of the ethylenically unsaturated silane monomer. Alternatively, it is also preferred to use 0.5 to 5.0%, based on total monomers, glycidyl methacrylate in combination with 0.5 to 2%, based on total monomers, of itaconic acid.

According to a preferred embodiment of the present invention, vinyl acetate and one or more further main monomers and/or one or more auxiliary monomers are copolymerized. Preferably, 50 to 99% of vinyl acetate, 1 to 40% of ethylene, and optionally up to 30% of one or more further main monomers and/or up to 10% of one or more auxiliary monomers are copolymerized. A copolymer is preferably prepared from a mixture comprising 1 to 40% by weight, based on total monomers, of ethylene, 59.9 to 98.9% by weight, based on total monomers, of vinyl acetate, 0.05 to 5% by weight, based on total monomers, of an ethylenically unsaturated epoxy group containing monomer, 0.05 to 5% by weight, based on total monomers, of a ethylenically unsaturated silane compound, and 0 to 20% by weight, based on total monomers, of one or more further main or auxiliary monomers. The ethylenically unsaturated epoxide group containing monomer is preferably glycidyl acrylate or glycidyl methacrylate, and the ethylenically unsaturated silane compound is preferably 3-methacryloxypropyl trimethoxysilane, vinyltrimethoxy silane or vinyltriethoxy silane. According to another preferred embodiment of the present invention, styrene, acrylic acid, and optionally one or more further main monomers and/or one or more auxiliary monomers are copolymerized. In the above cases, the further main monomer is preferably selected from the group consisting of methyl acrylate, methyl methacrylate, 2-ethylhexyl acrylate, butyl acrylate, vinyl propionate, vinyl laurate, vinyl palmitate, vinyl myristate, vinyl pivalate, vinyl 2-ethylhexanoate, and vinyl esters of an α-branched carboxylic acid having 5 to 11 carbon atoms, especially vinyl esters of Versatic acid having 9 to 11 carbon atoms (i.e., VeoVa9™, VeoVa10™, VeoVa11™), and combinations thereof.

The monomers used in the process of the invention are to be selected such as to produce a polymer or copolymer having the properties that are needed for the desired end application. This can be done by setting the glass transition temperature of the polymers formed and the corresponding copolymerization parameters in a manner which is known to the person skilled in the art.

The selection of the main monomers and auxiliary monomers is generally made in a way that a glass transition temperature T_{g} of about −70° C. to about 110° C., preferably of about −50° C. to about 70° C., more preferably of about −30° C. to about 60° C. is obtained. The glass transition temperature T_{g} of the polymers can be determined in a known way by means of differential scanning calorimetry (DSC) using a heating rate of 10° C./min and determining the mid point of the heating curve. The T_{g} may also be calculated approximately in advance by means of the Fox equation, in a conventional manner.

### Addition of Further Silanes

It is further possible to add an additional hydrolyzable silicon compound before, during or after the polymerization reaction phase. According to a preferred embodiment of the present invention, the hydrolyzable silicon compound is selected from the group consisting of hydrolyzable epoxy silanes, hydrolyzable amino silanes, hydrolyzable mercapto silanes, hydrolyzable alkoxy silane compounds having the formula (R⁶)ₙ—Si—(OR⁷)₄₋ₙ, wherein n is 0, 1, 2 or 3, and R⁶ and R⁷ are each independently a straight-chain or branched C₁-C₁₆ alkyl, and combinations thereof.

Suitable hydrolyzable epoxy silanes include, for example, 3-glycidoxypropyl trimethoxysilane (also known under the trademark Geniosil® GF80) and 3-glycidoxypropyl triethoxysilane. Further suitable hydrolyzable epoxy silanes include silane oligomers comprising, for example, epoxy functionalities, such as SILQUEST® CoatOSil*MP200.

Suitable hydrolyzable amino silanes include, for example, 3-(2-aminoethylamino)propyl trimethoxysilane, and 3-(2-aminoethylamino)propyl methyldimethoxysilane.

Suitable hydrolyzable mercapto silanes include, for example, mercaptosilanes of the general formula HS—(CR⁴₂)₁₋₃—SiR⁵₃, where R⁴ is identical or different and is H or a C₁ to C₆ alkyl group, R⁵ is identical or different and is a C₁ to C₆ alkyl group or C₁ to C₆ alkoxy group, at least one of the radicals R⁵ being an alkoxy group. Preferably, the hydrolyzable mercapto silanes are selected from the group consisting of 3-mercaptopropyl triethoxysilane, 3-mercaptopropyl trimethoxysilane, and 3-mercaptopropyl methyldimethoxysilane.

Suitable hydrolyzable alkoxy silane compounds include, for example, silanes of the formula (R⁶)ₙ—Si—(OR⁷)₄₋ₙ, wherein n is 0, 1, 2 or 3, and R⁶ and R⁷ are each independently a straight-chain or branched C₁-C₁₆ alkyl. Preferably, the hydrolyzable silane compound is selected from the group consisting of tetramethoxysilane, tetraethoxysilane, methyltrimethoxysilane, ethyltrimethoxysilane, propyltrimethoxysilane, butyltrimethoxysilane, pentyltrimethoxysilane, hexyltrimethoxysilane, methyltriethoxysilane, ethyltriethoxysilane, propyltriethoxysilane, butyltriethoxysilane, pentyltriethoxysilane and hexyltriethoxysilane. Particularly preferred hydrolyzable silicon compounds are 3-glycidoxypropyl trimethoxysilane, 3-glycidoxypropyl triethoxysilane, 3-(2-aminoethylamino)propyl trimethoxysilane, 3-mercaptopropyl trimethoxysilane, tetraethoxysilane, methyltriethoxysilane, hexyltriethoxysilane, and combinations thereof.

### Initiators and Regulators

The polymerization of the ethylenically unsaturated monomers takes place in the presence of at least one initiator for the free-radical polymerization of these monomers. Suitable initiators for the free-radical polymerization, for initiating and continuing the polymerization reaction, include all known initiators which are capable of initiating a free-radical, aqueous polymerization in heterophase systems. These initiators may be water-soluble initiators (including those initiators which are not only water-soluble, but additionally also oil-soluble), water-insoluble initiators (i.e. those initiators which are only oil-soluble), or combinations thereof. According to the present invention, it is preferred to use water-soluble initiators.

According to the present invention, water-soluble free radical initiators are initiators which have a solubility of at least 1% by weight at 20° C. and atmospheric pressure in demineralized water.

Suitable initiators include, for example, peroxides and azo compounds. Examples of water-soluble free radical initiators include inorganic peroxides including hydrogen peroxide and peroxodisulfates, such as the mono- or dialkali salts, in particular the respective sodium or potassium salts, or the mono- or diammonium salts of peroxodisulfuric acid. Further examples include organic hydroperoxides, such as cumyl hydroperoxide or tert-butyl hydroperoxide (TBHP). Further examples for water-soluble free radical initiators include azo initiators, such as 2,2′-azobis(2-methylpropionamidine) dihydrochloride.

The polymerization reaction may be started with the above initiators, for example, by means of thermal initiation. Alternatively, the aforementioned compounds may also be used within a redox system, wherein reducing agents are used in combination with the above oxidizing agents. Reducing agents which can be used include transition metal salts, such as iron(II)/(III) salts, alkali metal salts of hydroxymethanesulfinic acid, such as sodium formaldehyde sulfoxylate dihydrate (RongalitoC) or the mixture of 2-hydroxy-2-sulfinateacetic acid disodium salt, 2-hydroxy-2-sulfonateacetic acid disodium salt, and sodium sulfite (Brüggollt® FF6/FF6M and Brüggolit® FF7), mercaptans of chain length C₁₀-C₁₄, but-1-ene-3-ol, hydroxylamine salts, sodium dialkyl dithiocarbamate, sodium sulfite, sodium bisulfite, sodium metabisulfite, sodium thiosulfate, ammonium bisulfite, sodium dithionite, acetone-bisulfite adduct, diisopropylxanthogen disulfide, ascorbic acid, tartaric acid, isoascorbic acid, sodium erythorbate, reducing sugars, boric acid, urea, and formic acid.

Examples of water-soluble reducing agents for the application in redox initiator systems include, for example, Rongalit® C, Brüggolit® FF6, Brüggolit® FF7 or sodium metabisulfite.

According to a preferred embodiment, a water-soluble redox initiator system is used, such as tert-butyl hydroperoxide, hydrogen peroxide or salts of peroxodisulfates (such as sodium persulfate, ammonium persulfate or potassium persulfate) in combination with Rongalit® C, Brüggolit® FF6, Brüggolit® FF7 or sodium metabisulfite.

According to a preferred embodiment of the present invention, the polymerization reaction is started by an initiator system consisting of one or more water-soluble free radical initiators. This means that the initiator system exclusively contains water-soluble free radical initiators and does not contain any initiators having a solubility of less than 1% by weight at 20° C. and atmospheric pressure in demineralized water.

The exclusive use of water-soluble initiators is preferred, since water-insoluble initiators are usually not very efficient in emulsion polymerization, owing to their poor transport via the water phase, and in some cases also lead to suspension polymerization, with the formation of large particles, which for certain applications is undesirable. The great advantage, then, is that the process of the invention permits significantly more economic preparation of the desired products, without detractions from their quality or performance, and the process of the invention is also possible on the commercial scale.

The amount of initiators or initiator systems used in the process of the present invention can be suitably selected in view of what is usual for aqueous polymerizations in heterophase reactions. In general, the amount of initiator used will not exceed 5% by weight, based on the total amount of monomers to be polymerized. The amount of initiators used, based on the total amount of monomers to be polymerized, is preferably in the range of 0.05 to 2.0% by weight.

In this context, it is possible for the total amount of initiator to be included in the initial charge to the reactor at the beginning of the polymerization. Alternatively, it is possible to include a portion of the initiator in the initial charge, and to add the remainder after the polymerization has been initiated, in one or more steps or continuously. The addition may be made separately or together with other components, such as emulsifiers. According to a preferred embodiment, the initiator is slowly added in the course of the polymerization reaction, for example with a rate of not more than 2% of the total amount of initiator to be added per minute, or preferably with a rate of not more than 1% of the total amount of initiator to be added per minute.

The molecular weight of the polymer dispersions obtained by the process of the present invention can be adjusted by adding small amounts of one or more transfer agents, i.e. molecular weight regulator substances. These transfer agents are generally used in an amount of up to 2% by weight, based on the total monomers to be polymerized. As transfer agents, it is possible to use all of the substances known in the art. Preference is given, for example, to organic thio compounds, silanes, allyl alcohols, and aldehydes.

### Stabilization System

Both during polymerization and thereafter, the polymer dispersion obtained by the process of the present invention may be stabilized in the form of an aqueous polymer dispersion or latex. The polymer dispersion therefore is preferably prepared in the presence of and will contain a stabilization system which generally comprises emulsifiers, in particular nonionic emulsifiers and/or anionic emulsifiers and or protective colloids. Mixtures of the different stabilizers can also be employed.

The amount of emulsifier employed is preferably at least 0.5% by weight, based on the total amount of monomers in the polymer dispersion. Generally, emulsifiers can be used in amounts up to about 8% by weight, based on the total amount of monomers in the polymer dispersion. The weight ratio of nonionic to anionic emulsifiers may vary within wide ranges, for example between 1:1 and 50:1. Preferred emulsifiers include nonionic emulsifiers having alkylene oxide groups and/or anionic emulsifiers having sulfate, sulfonate, phosphate and/or phosphonate groups. Such emulsifiers, if desired, can be used together with molecularly or dispersely water-soluble polymers, preferably together with polyvinyl alcohol.

Examples of suitable nonionic emulsifiers include acyl, alkyl, oleyl, and alkylaryl ethoxylates. These products are commercially available, for example, under the tradename Genapol™, Lutenso™ or Emuan™. They include, for example, ethoxylated mono-, di-, and tri-alkylphenols (EO degree: 3 to 80, alkyl substituent radical: C₄ to C₁₂) and also ethoxylated fatty alcohols (EO degree: 3 to 80; alkyl radical: C₈ to C₃₆), especially C₁₀-C₁₄ fatty alcohol (EO 3-80) ethoxylates, C₁₁-C₁₅ oxo-process alcohol (EO 3-80) ethoxylates, C₁₆-C₁₈ fatty alcohol (EO 3-80) ethoxylates, C₁₁ oxo-process alcohol (EO 3-80) ethoxylates, C₁₃ oxo-process alcohol (EO 3-80) ethoxylates, polyoxyethylenesorbitan monooleate with 20 ethylene oxide groups, copolymers of ethylene oxide and propylene oxide having a minimum ethylene oxide content of 10% by weight, the polyethylene oxide (EO 3-80) ethers of oleyl alcohol, and the polyethene oxide (EO 3-80) ethers of nonylphenol. Particularly suitable are the polyethylene oxide (EO 3-80) ethers of fatty alcohols, more particularly of oleyl alcohol, stearyl alcohol or C₁₁ alkyl alcohols.

The amount of nonionic emulsifiers used for preparing the polymer dispersions is typically about 1% to about 8% by weight, preferably about 1% to about 5% by weight, more preferably about 1% to about 4% by weight, based on the total amount of monomers. Mixtures of nonionic emulsifiers can also be employed.

Examples of suitable anionic emulsifiers include sodium, potassium, and ammonium salts of linear aliphatic carboxylic acids of chain length C₁₂ to C₂₀, sodium hydroxyoctadecane-sulfonate, sodium, potassium, and ammonium salts of hydroxy fatty acids of chain length C₁₂ to C₂₀ and their sulfonation and/or sulfation and/or acetylation products, secondary alkyl sulfonates, alkyl sulfates, including those in the form of triethanolamine salts, alkyl(C₁₀-C₂₀) sulfonates, alkyl(C₁₀-C₂₀) arylsulfonates, and their sulfonation products, lignosulfonic acid and its calcium, magnesium, sodium, and ammonium salts, resin acids, hydrogenated and dehydrogenated resin acids, and their alkali metal salts, dodecylated sodium diphenyl ether disulfonate, sodium lauryl sulfate, sulfated alkyl or aryl ethoxylate with EO degree between 1 and 10, for example ethoxylated sodium lauryl ether sulfate (EO degree 3) or a salt of a bisester, preferably of a bis-C₄-C₁₈ alkyl ester, of a sulfonated dicarboxylic acid having 4 to 8 carbon atoms, or a mixture of these salts, preferably sulfonated salts of esters of succinic acid, more preferably salts, such as alkali metal salts, of bis-C₄-C₁₈ alkyl esters of sulfonated succinic acid, or phosphates of polyethoxylated alkanols or alkylphenols.

The amount of anionic emulsifiers used is preferably in a range of from about 0.1% to about 3.0% by weight, preferably of from about 0.1% to about 2.0% by weight, more preferably of from about 0.5% to about 1.5% by weight, based on the total amount of monomers. Mixtures of anionic emulsifiers can also be employed.

The aqueous polymer dispersions may further comprise, as part of the stabilization system, a protective colloid which is preferably a water-soluble or colloidal dispersible polymer. The protective colloid may be based on cellulose ethers, polyvinyl alcohol, polyvinyl pyrrolidone, polyurethane-based copolymers, polyacrylic acid, maleic acid-styrene copolymers or other water soluble polymers. Suitable protective colloids used in the polymer dispersions obtained by the process of the present invention include water-soluble or water-dispersible polymeric modified natural substances based on cellulose ethers. Such cellulose ethers have a Hopper viscosity, when tested as a 1% by weight aqueous solution in water at 25° C., of about 5 to about 5,000 mPas, preferably of about 10 to about 1,500 mPas, more preferably of about 10 to about 500 mPas. Mixtures of celluloses ethers may be used to achieve these viscosity values. Examples of suitable cellulose ether materials include methyl cellulose, hydroxyethyl cellulose, hydroxypropyl cellulose, hydroxypropyl methyl cellulose, ethyl hydroxyethyl cellulose, methyl hydroxyethyl cellulose and combinations thereof. Suitable cellulose ether materials are available under the tradenames Natroso® and Tyose®. Hydroxyethyl cellulose (HEC), which is commercially available under the tradename Natroso®, is most preferred.

The protective colloids, preferably hydroxyethyl cellulose and polyvinyl alcohol, may be hydrophobically modified, for example by alkyl, aryl, cycloalkyl, or hydrophilically modified, for example by carboxyl, sulfate, sulfonic, hydroxyl. Hydrophobically modified cellulose ethers may comprise cellulose ethers which have been hydrophobically modified with long chain hydrocarbon groups to reduce their water solubility. Hydrophobically modified cellulose ethers of this type are those described, for example, in U.S. Pat. Nos. 4,228,277, 4,352,916 and 4,684,704.

The protective colloids can be used individually or in combination. In the case of combinations, the two or more colloids can each differ in their molecular weights or they can differ in their molecular weights and in their chemical composition, such as the degree of hydrolysis in the case of polyvinyl alcohols, for example.

The preferred protective colloids are hydroxyethyl cellulose and polyvinyl alcohol. Suitable polyvinyl alcohols have degrees of hydrolysis of from 60 to 100 mol % and Höppler viscosities of the 4% aqueous solutions at 20° C. of 2 to 70 mPas, especially from 4 to 40 mPas.

When protective colloids are used, the amount thereof, based on the total amount of monomers used, is typically from 0.1 to 10% by weight, preferably from 0.2 to 8% by weight, even more preferably from 0.4 to 6% by weight.

In a preferred embodiment, the present dispersions contain no protective colloid at all, or the amount of protective colloid, based on the total amount of monomers used, is less than 1% by weight, more preferably less than 0.7% by weight.

In addition to the emulsifiers and protective colloids that are used during the emulsion polymerization of the copolymers herein, it is also possible to add further emulsifiers, protective colloids and/or other stabilizers after the polymerization as post-additions.

### (Co)Polymer Dispersion Preparation

The (co)polymer dispersions comprising the aqueous (co)polymers obtained by the process of the present invention can be prepared using emulsion polymerization procedures which result in the preparation of polymer dispersions in aqueous latex form. Such preparation of aqueous polymer dispersions of this type is well known and has already been described in numerous instances and is therefore known in the art. Such procedures are described, for example, in U.S. Pat. No. 5,849,389, and in the Encyclopedia of Polymer Science and Engineering, Vol. 8, p. 659 (1987).

The polymerization may be carried out in any manner known in one, two or more stages with different monomer combinations, giving polymer dispersions having particles with homogeneous or heterogeneous, e.g., core shell or hemispheres, morphology. Other monomer profiles as well, however, can be utilized, and are known to the person skilled in the art, for the purpose of generating heterogeneous particle morphologies. In one preferred embodiment, copolymers with a heterogeneous morphology are produced by polymerizing a first monomer or first mixture of monomers to form a first polymer and thereafter polymerizing a second monomer or second mixture of monomers onto the first polymer.

Any suitable reactor system may be employed. The polymerisation can be undertaken, for example, by batch or semi batch, i.e. by processes in which all the monomer is added upfront or in which part of the monomer is slowly added in the course of the polymerization reaction.

Monomers can be added to the polymerization vessel continuously, incrementally or as a single charge addition of the entire amounts of monomers to be used. Monomers can be employed as pure monomers or can be used in the form of a pre-mixed emulsion. The monomers may be metered either together or in separate feed streams. Ethylene as a co-monomer can be added at any stage by pumping (or adding/feeding) it into the polymerization vessel and maintaining it under appropriate pressure therein. In order to control the ethylene addition, the ethylene can be added with a constant pressure or with a constant feed rate. It is also possible to combine both methods, for example by starting the addition with a constant pressure and then, after a certain polymerization time, applying a constant feed rate, or vice versa.

According to a preferred embodiment of the present invention, up to 100% of the main monomers, based on the total amount of main monomers to be copolymerized, are initially charged and the remainder is continuously added in the course of the polymerization reaction phase. This encompasses a complete pre-charging of the monomers as well as the initial charge of only part of the monomers to be (co)polymerized. According to a more preferred embodiment of the present invention, a portion of the monomers employed, preferably up to about 50%, more preferably about 1% to about 50%, even more preferably about 5% to about 30% by weight, based on total monomers, is introduced as an initial charge in order to start the polymerization, and the remainder of the monomers is metered into the reaction mixture during the polymerization reaction phase.

Furthermore, it may be advantageous in certain embodiments to set specific particle sizes and particle size distributions at the beginning of the polymerization, to carry out a seed polymerization or to include a separately prepared seed in the initial charge. Where a seed latex is used in the process of the present invention, it is used before the beginning of the emulsion polymerization, for example with about 0.5 to about 15% by weight of the dispersion, preferably with about 1 to about 10% by weight of the dispersion.

The way of combining the several polymerization ingredients, i.e. emulsifiers, monomers, initiators, protective colloids, etc., can vary widely. Generally an aqueous medium containing at least some of the emulsifier(s) can be initially formed in the polymerization vessel with the various other polymerization ingredients being added to the vessel thereafter. The emulsifier used for stabilization and/or the protective colloid, where used, can either be introduced completely at the beginning of the polymerization, in the initial charge, or else part may be included in the initial charge and part metered in, or the entire amount metered in during the performance of the polymerization. It is preferred to include the entire emulsifier or a large part of the emulsifier in the initial charge.

The emulsion polymerization of the invention is preferably performed at least partly under pressure. The polymerization generally takes place under pressure if appropriate, preferably from 2 to 150 bar, more preferably from 5 to 100 bar, even more preferably from 10 to 85 bar.

Where a pressure stage is operated in the process of the invention, in the metering of the gaseous monomer may be commenced only after 10% to 50% by weight of the liquid main monomers in the reaction mixture have been converted, thus forming heterogeneous particle morphologies. Where the process of the invention is operated with a pressure stage, the metering of the gaseous monomer may alternatively also commence at the beginning of the emulsion polymerization, so that conversion takes place together with the liquid monomers, forming homogeneous particle morphologies.

In a typical polymerization procedure involving, for example, aqueous copolymer dispersions, monomers, such as vinyl acetate, ethylene, and other monomers, can be polymerized in an aqueous medium under pressures up to 120 bar in the presence of one or more initiators, at least one emulsifying agent and a protective colloid component. The aqueous reaction mixture in the polymerization vessel can be maintained by a suitable buffering agent at a pH of about 2 to about 7.

According to a preferred embodiment of the present invention, 50 to 99% of vinyl acetate, 1 to 40% of ethylene, and optionally up to 30% of one or more further main monomers and/or up to 10% of one or more auxiliary monomers are copolymerized. In this case, it is preferred that, at the start of the polymerization reaction phase, the ethylene pressure is increased to a value amounting for at least 30%, preferably at least 60%, of the total amount of ethylene to be copolymerized, and then up to about 50% to 60% of the duration of the polymerization reaction phase, the ethylene pressure is maintained at a value amounting for at least 50% of the total amount of ethylene to be copolymerized, and subsequently, no further ethylene is added so that the polymerization of the remaining ethylene in the reaction vessel leads to a continuous decrease in the ethylene pressure. In this case, the addition of ethylene is preferably controlled by applying a predetermined ethylene pressure and not by controlling the feed rate.

### Post-Polymerization and Further Treatment

Residual monomer can be removed following the end of the claimed process for the emulsion polymerization. This can be achieved by employing known methods. As already explained above, the residual monomers generally account for not more than about 2% by weight, based on the total monomers, preferably not more than about 1% by weight, particularly preferably not more than about 0.5% by weight, based on the total monomers. Accordingly, a post-polymerization reaction may optionally take place subsequently to the claimed process for the emulsion polymerization wherein the post-polymerization reaction starts after up to 98% by weight, based on total monomers, have been polymerized, preferably after up to 99% by weight, based on total monomers, have been polymerized, particularly preferably after up to 99.5% by weight, based on total monomers, have been polymerized.

This post-polymerization may take place at the same temperature as the end temperature or at a lower temperature. The post-polymerization phase is generally followed by a cooling phase. Post-polymerization may include a final redox treatment which is preferably performed in a different reactor. Such a final redox treatment is not part of the above-described polymerization reaction.

Accordingly, the present invention also relates to a process for the emulsion polymerization of free-radically polymerizable, ethylenically unsaturated main monomers, and optionally further auxiliary monomers copolymerizable therewith, to prepare a polymer having low residual monomer content, the process comprising the above-described process for the emulsion polymerization, and subsequently a post-polymerization reaction.

Volatile residual monomers may also be removed by means of distillation, preferably under reduced pressure, and, where appropriate, with inert entraining gases such as air, nitrogen or steam passed through or over the product. Methods of removing residual monomers are known from WO-A-04/22609, for example.

Following polymerization or post-polymerization, the solids content of the resulting aqueous polymer dispersions can be adjusted to the level desired by the addition of water or by the removal of water by distillation. Generally, the desired level of polymeric solids content after polymerization is from about 20% by weight to about 70% by weight, based on the total weight of the polymer dispersion, preferably from about 30% by weight to about 65% by weight, more preferably from about 40% by weight to about 60% by weight.

The pH of the polymer dispersions prepared in accordance with the invention is typically between 2 and 8, preferably between 4 and 7.

The average particle size is typically less than 1.2 μm, preferably less than 1,000 nm, and more preferably less than 400 nm (determined by means of laser diffraction or by means of laser aerosol spectroscopy, as described below, depending on the size of the particles).

The viscosity of the polymer dispersions prepared in accordance with the present invention is typically between 10 mPas and 50,000 mPas, preferably between 100 mPas and 20,000 mPas, and more preferably between 100 and 15,000 mPas (measured by means of Brookfield viscometer at 23° C., 20 rpm, and the corresponding spindle for the correct measuring range).

### Use of the Polymer Dispersions

The present invention also refers to an aqueous (co)polymer dispersion comprising at least one (co)polymer formed by the process of the present invention.

The polymer dispersions of the invention can be used in the typical fields of application.

The polymer dispersions of the invention can be used as binders for any desired substrates, for example as binders in pigment-containing, aqueous preparations which serve for the coating of substrates (in particular paints), carpet back coatings, paper (in particular paper saturation and paper coating), adhesives, or textiles (in particular textile printing and textile finish) and nonwovens (engineered fabrics). Moreover, the aqueous copolymer dispersions according to the invention can be used, for example, as binders for wood fiber board or artificial leather, as binders for insulating materials made from paper fiber or polymeric fiber, and also as binders for emulsion finishes and glazes, sealing compounds and sealing compositions, preferably for porous components.

According to a particularly preferred embodiment of the present invention, the dispersions of the invention are used as binders for paints such as, for example, emulsion paints for the interior and/or exterior sector, in particular low-emission interior paints, low-emission exterior paints, or paint formulations above the critical pigment volume concentration (PVC). “Low-emission” paints have a low emission regarding Total Volatile Organic Compound (TVOC) (according to the ISO 11890-2 method for polymer dispersions TVOC content determination; see below). Coatings prepared with the aqueous copolymer dispersions described herein will generally contain less than 2,000 ppm TVOC by weight based on the total weight of the coating, preferably less than 1,000 ppm, more preferably less than 500 ppm, and even more preferably less than 100 ppm, according to ISO 11890-2.

The aqueous copolymer dispersions according to the present invention preferably have a formaldehyde content of less than 100 ppm, more preferably less than 30 ppm, and even more preferably less than 10 ppm, as determined by the acetyl-acetone method according to the VdL-RL 03 test method (VdL Guideline 03) for coating compositions.

The copolymer dispersions as hereinbefore described may be combined with filler material, additional water and/or any optional other ingredients, such as one or more auxiliaries, to form the aqueous coating compositions herein. The solids content of the aqueous compositions so formed will generally range from about 30% by weight to about 75% by weight of the total composition. More preferably, the solids content of the aqueous coating compositions herein will range from about 40% by weight to about 65% by weight of the total composition. These are to be understood as meaning all constituents of the preparation except for water, but at least the total amount of solid binder, filler, pigment, plasticizer and polymeric auxiliaries.

Pigments which may be used are all pigments known to the person skilled in the art for said intended use. Preferred pigments for the aqueous preparations according to the invention, preferably for emulsion paints, are, for example, titanium dioxide, preferably in the form of rutile, barium sulfate, zinc oxide, zinc sulfide, basic lead carbonate, antimony trioxide and lithopone (zinc sulfide and barium sulfate). The aqueous preparations may also contain colored pigments, for example iron oxides, carbon black, graphite, luminescent pigments, zinc yellow, zinc green, ultramarine, manganese black, antimony black, manganese violet, Paris blue or Schweinfurt green. In addition to the inorganic pigments, the preparations according to the invention may also contain organic colored pigments, for example sepia, gamboge, Cassel brown, toluidine red, para red, Hansa yellow, indigo, azo dyes, anthraquinoid and indigoid dyes and dioxazine, and quinacridone, phthalocyanine, isoindolinone and metal complex pigments.

Fillers which may be used are all fillers known to the person skilled in the art for said intended use. Preferred fillers are aluminosilicates, such as, for example, feldspars, silicates, such as, for example, kaolin, talc, mica, magnesite, alkaline earth metal carbonates, such as, for example, calcium carbonate, for example in the form of calcite or chalk, magnesium carbonate, dolomite, alkaline earth metal sulfates, such as, for example, calcium sulfate, and silica. The fillers can be used either as individual components or as filler mixtures. Filler mixtures, such as, for example, calcium carbonate/kaolin and calcium carbonate/talc, are preferred in practice. Synthetic resin-bound renders may also contain relatively coarse aggregates, such as sands or sandstone granules. In general, finely divided fillers are preferred in emulsion paints.

In order to increase the hiding power and to save white pigments, finely divided fillers, such as, for example, precipitated calcium carbonate or mixtures of different calcium carbonates having different particle sizes, are preferably frequently used in emulsion paints. Mixtures of colored pigments and fillers are preferably used for adjusting the hiding power of the hue and the depth of color.

In one embodiment, the coating composition may comprise from 30 to 90% of at least one filler, from 0.1 to 25% of at least one pigment, and from 5 to 60%, preferably from 5 to 20% of the aqueous (co)polymer dispersion of the present invention.

The customary auxiliaries include wetting agents or dispersants, such as sodium, potassium, or ammonium polyphosphates, alkali metal and ammonium salts of polyacrylic acids and of polymaleic acid, polyphosphonates, such as sodium 1-hydroxyethane-1,1-diphosphonate, and naphthalenesulfonic acid salts, in particular sodium salts thereof. In addition, suitable amino alcohols, such as, for example, 2-amino-2-methylpropanol, may be used as dispersants. The dispersants or wetting agents are preferably used in an amount of from 0.1 to 2% by weight, based on the total weight of the emulsion paint.

Furthermore, the auxiliaries may also comprise thickeners, for example cellulose derivatives, such as methylcellulose, hydroxyethylcellulose and carboxymethylcellulose, and furthermore casein, gum Arabic, tragacanth gum, starch, sodium alginate, polyvinyl alcohol, polyvinylpyrrolidone, sodium polyacrylates, water-soluble copolymers based on acrylic and (meth)acrylic acid, such as acrylic acid/acrylamide and (meth)acrylic acid/acrylic ester copolymers and so-called associative thickeners, such as styrene/maleic anhydride polymers or preferably hydrophobically modified polyetherurethanes (HEUR) known to the person skilled in the art, hydrophobically modified acrylic acid copolymers (HASE) polyetherpolyols. Inorganic thickeners, such as, for example, bentonites or hectorite, may also be used. The thickeners are preferably used in amounts of from 0.1 to 3% by weight, particularly preferably from 0.1 to 1% by weight, based on the total weight of the aqueous preparation.

In addition, waxes based on paraffins and polyethylene, and dulling agents, antifoams, preservatives and water repellents, biocides, fibers and further additives known to the person skilled in the art may also be used as auxiliaries in the aqueous preparations according to the invention.

The dispersions according to the present invention can be used to produce not only solvent- and plasticizer-free preparations but also coating systems which contain solvents and/or plasticizers as film formation auxiliaries. Film formation auxiliaries are generally known to the person skilled in the art and can be used generally in amounts of from 0.1 to 20% by weight, based on the (co)polymer present in the preparation, so that the aqueous preparation has a minimum film formation temperature of less than 15° C., preferably in the range from 0° C. to 10° C. The use of these film formation auxiliaries is generally not necessary in view of the advantageous properties of the (co)polymer dispersions according to the invention. In a preferred embodiment, the aqueous preparations according to the invention therefore contain no film formation auxiliary. The coating composition may have a minimum film forming temperature of less than or equal to 5° C. without addition of film forming agents.

The aqueous preparations according to the invention are stable fluid systems which can be used for coating a multiplicity of substrates. Consequently, the present invention also relates to methods for coating substrates and to the coating materials themselves. Suitable substrates are, for example, wood, concrete, mineral substrates, metal, glass, ceramics, plastic, renders, wallpapers, paper and coated, primed or weathered substrates. The application of the preparation to the substrate to be coated is effected in a manner dependent on the form of the preparation. Depending on the viscosity and the pigment content of the preparation and on the substrate, the application can be effected by means of roll-coating, brushing, knife-coating or as a spray.

The pigment volume concentration (PVC) of the pigment-containing, aqueous preparations according to the invention is in general above 5%, preferably in the range from 10 to 90%. In the context of using the aqueous copolymer dispersions in coating compositions, a particular feature of the aqueous copolymer dispersions is the ability to have a very good wet scrub resistance even at a high pigment volume concentration (PVC), i.e. in highly filled formulated compositions above the critical PVC. Accordingly, in particularly preferred embodiments, the PVCs are in the range from 60 to 90%, in particular from 70 to 90%. The invented emulsions are also suitable for medium to low PVC paints like satin and semi-gloss paints. In this case, the PVCs are preferably in the range from 10 to 45%.

Furthermore, the polymer dispersions of the invention may be used as an adhesive for any desired substrates, preferably for the adhesive bonding of porous and semi-porous substrates. These applications include, for example, bonds of paper, card, corrugated cardboard, foam material, cement, leather, textiles or pressed laminates, where appropriate in combination with nonporous substrates, polymeric films. Examples of preferred adhesive bonds are paper/paper or paper/polymeric film combinations. Further preferred adhesive bonds are polymeric film/polymeric film combinations.

The dispersions can be used as they are or in the form of water-redispersible dispersion powders. For improved redispersion it is preferable to add protective colloids, such as polyvinyl alcohol and/or cellulose ethers, and/or suitable anticaking agents. These powders may be obtained in a conventional way by spray-drying of the dispersions.

The dispersions or dispersion powders of the invention can be used, for example, in construction products, in combination with hydraulically setting binders, cements, examples being Portland, aluminate, slag, magnesia, and/or phosphate cement, gypsum and waterglass, for producing construction adhesives, especially tile adhesives and adhesives for integrated thermal insulation systems, walls or ceilings, renders, trowelling compounds, flooring compounds, furniture-foil, leveling compounds, grouts, jointing mortars, and plasters.

It is particularly preferred to use the aqueous (co)polymer dispersion according to the present invention as a binder in paints, paper saturation and paper coating, adhesives, nonwovens, textiles, carpet back-coatings, construction, or powder.

The following examples serve to illustrate the present invention, without, however, limiting the scope of the invention.

### EXAMPLES

### Copolymer Dispersion Particle Size Determination

The size of solid particles within the copolymer dispersions used herein was determined by laser aerosol spectroscopy (LAS). This LAS method is described in the publication Kunstharz Nachrichten 28; “Characterization and Quality Assurance of Polymer Dispersions”; Oktober 1992, Dr. J. Paul Fischer. The method uses a Nd:YVO4 Laser (Millenia II) supplied by Spectra Physics with a laser power of 2 W and a wave length of 532 nm. The detector was a Bialkali Photocathode Typ 4517 supplied by Burle (formerly RCA). The scattered light of the spray dried single particles was detected at 40°. The evaluation of the data was done with a multi-channel analyzer by TMCA with 1024 channels. For the particle size determination, 0.2 ml of a dispersion sample were diluted in 100 ml of deionized and filtered water (conductivity of 18.2 μS/m). The sample was spray dried over a Beckmann-nozzle and dried with nitrogen gas. The single particles were neutralized with beta radiation (Kr-85) and then investigated by single particle laser scattering. By applying this method, the number and mass mean values within the range of 80 nm to 550 nm and mean particle size values dn, dw, dz and dw/dn were obtained.

The size of solid particles within the copolymer dispersions used in examples 8 to 15 was determined by laser diffraction using a commercially available Beckmann Coulter LS 13320 device and a detailed description of the method and the device is available from Beckman Coulter. For the actual measurement ca. 5 drops of every sample were diluted in 5 ml of water (depends on actual particle size). After thorough mixing the dilution was transferred into the measurement chamber. A further dilution of the sample was done automatically by the device in order to yield the optimum diffraction intensity for the method and device. 1 min ultra-sonic treatment is used at 20 kHz, 70 W. For measuring of the small particles the PIDS (Polarization Intensity Differential Scattering) was used. By applying this method, the number and mass mean values within the range of 0.017-2,000 μm and mean particle size values dn, dw, dz and dw/dn were obtained.

### Copolymer Glass Transition Temperature (Tg) Determination

The glass transition temperature, Tg, was determined by using a commercial differential scanning calorimeter Mettler DSC 820 at 10 K/min. For evaluation, the second heating curve was used and the DIN mid point calculated.

### Copolymer Dispersion Volatile Organic Compound/Vinyl Acetate Monomer Content (DIN ISO 11890-2)

The total volatile organic compound content of the copolymer dispersion was determined by using the ISO 11890-2 test method. This method determines the residual levels of Volatile Organic Components (VOC) or residual monomers like vinyl acetate by direct injection into a capillary gas chromatographic column. The used method followed the DIN ISO 11890-2 directive where the Total Volatile Organic Component (TVOC) is defined as the sum of all volatile organic components with a boiling point lower than tetradecane. This component has a boiling point of 253° C. A Perkin Elmer Gas Chromatograph (AutoSystem XL) fitted with PPC (Pneumatic Pressure control) was used with a Varian column V624, 60 meters, 320 μm internal diameter and 1.8 μm film thickness. The carrier gas was H₂. The detector was a FID. For sample preparation, approximately 150 μl of sample were placed into a tared vial using a Gilson Micromann 250 positive displacement pipette. The auto sampler vial was weighed (g), and the result was noted as the divisor value. Approximately 1.5 ml of diluent solution (containing 100 ppm of methyl isobutyl ketone (MIBK) in deionized water as internal standard) were added to the auto sampler vial. The auto sampler vial was weighed (g), and the result was noted as the multiplier. The auto sampler vial was mixed thoroughly using a vortex mixer until the solution in the vial was completely homogenous. The sample vial was then placed on the sampling carousel of the Gas Chromatograph and measured according to ISO 11890-2. Each single VOC/residual monomer value was calibrated initially. The result was the sum of all singles VOC values which is the TVOC parameter or just the individual residual monomer in ppm.

### The Fikentscher K Value

The Fikentscher K value range (H. Fikentscher, Cellulosechemie 13 (1932), 58-64 and 71-74) is a measure of intrinsic viscosity analogous to DIN 53726, and indicative of the molecular weight of a polymer. Usually the increase of the K value is linked to higher strength and improved scrubbability. To determine the K value, an equivalent of 1 g of dry polymer (=2 g of a 50% solids containing dispersion) was dissolved in 100 ml dimethyl formamide (DMF) at room temperature while stirring (until completely dissolved, at least 1 h), and the viscosity of the solution at 23° C. was determined, using a Mikro-Ostwald-Viscometer (Capillary type 518 13/I c [2 ml]; Schott AVS 400+CT1150). Then, the viscosity of 1 g of water in 100 ml DMF at 23° C. was determined in the same viscometer. The viscosity readings and the polymer concentrations were inserted into the following equation (A) and the k value was calculated. The K value was obtained by multiplying the k value by 1000.

log η_{c}/ηₒ=[(75*k²)/(1+1.5k*c)+k]*c Equation (A):

In the following, four groups of examples A to D are described which are independent of each other. Each group of examples A to D contains at least one example according to the present invention and at least one comparative example. The total conversion at the start temperature, at the end temperature and during the increase of the polymerization temperature was calculated in the following examples from the amounts of monomers added in the course of the polymerization reaction.

### Example A

### Example A-1

### VAE-Based Copolymer Dispersion Preparation

Into a pressure reactor fitted with an anchor stirrer (running at 150 rpm), a heating jacket, dosage pumps and having a volume of 30 liters, a water based solution of the following components is added:

| | |
|---|---|
| 10245 g | Water (deionized) |
| 164 g | Polyvinyl alcohol solution (29%) in deionized water, |
| | i.e., partially hydrolyzed [88 hydrolysis (mole %)] that |
| | forms a 4% solution viscosity of 4.50 cP ± 0.50 |
| | at 20° C. |
| 563 g | C11 Alkyl polyglycol ether (28 mols of Ethylene Oxide)- |
| | nonionic emulsifier (70% in deionized water). |
| 234 g | C11 Alkyl polyglycol ether (7 mols of Ethylene Oxide) |
| | sodium sulfate - anionic emulsifier (30% in |
| | deionized water). |
| 222 g | Sodium vinylsulfonate (30% in deionized water). |
| 33.3 g | Sodium acetate (anhydrous) |
| 5.25 g | Sodium meta bisulfite |
| 0.0302 g | Mohr's Salt (Fe²⁺ Salt) |
| 1.59 g | Defoamer Agitan 282 |

The polyvinyl alcohol (29%) is dissolved in the deionized water at 90° C. for 2 hours. The reactor is purged with nitrogen to eliminate oxygen. Out of a total amount of 11551 g of vinyl acetate, 10% of the vinyl acetate is added to the water phase in the reactor. The ethylene valve is opened and the reactor is pressurized to 30 bar at ambient temperature (ca. 56% of ethylene stage 1 at 25° C.) and is then dosed again (total amount of ethylene: 1575 g).

The reactor temperature is ramped up to 75° C. At 60° C. (the start temperature of the polymerization phase), the initiator feed, which is sodium peroxodisulfate (19.3 g in 813 g of deionized water), is added (over 60 min at a rate of approx. 380 g/h) into the reactor. At 65° C., the rest of the vinyl acetate (90%) together with 65.6 g of glycidyl methacrylate is fed over 60 min into the reactor. At the same temperature (65° C.) the ethylene valve is opened again and the rest of the ethylene (44%) is fed into the reactor over approx. 10 min at maximum pressure of 56 bar at 75° C. When the ethylene addition is finished (at temperature 75° C.) and the reaction shows exothermic behavior, the reactor temperature is ramped up to 115° C. by increasing the jacket temperature up and/or by using the polymerization heat. When the monomer feed (VAM) is completed, the initiator rate is increased to a maximum rate of 1200 g/h. After the initiator feed is finished (the end of the polymerization phase), the reaction temperature is maintained at 85° C. for 30 min. The reactor is then cooled down to approximately 40° C. and the batch is released. A final redox treatment is made at this point by introducing Brüggolit FF 6 (a sodium salt of a sulfinic acid derivative, obtained from L. Brueggemann K G) (13 g in 126 g of deionized water) and afterwards Trigonox AW 70 (28 g). The product is stirred for 30 min before discharge.

### Example A-2

### VAE-Based Copolymer Dispersion Preparation

Same Recipe and Process as example 1 but the temperature is increased to 120° C. (end temperature).

### Example A-3 (Comparative)

### VAE-Based Copolymer Dispersion Preparation

Into a pressure reactor fitted with an anchor stirrer (running at 150 rpm), a heating jacket, dosage pumps and having a volume of 30 liters, a water based solution of the following components is added:

| | |
|---|---|
| 10295 g | Water (deionized) |
| 454 g | Polyvinyl alcohol solution (29%) in deionized water, |
| | i.e., partially hydrolyzed [88 hydrolysis (mole %)] that |
| | forms a 4% solution viscosity of 4.50 cP ± 0.50 |
| | at 20° C. |
| 564 g | C11 Alkyl polyglycol ether (28 mols of Ethylene Oxide)- |
| | nonionic emulsifier (70% in deionized water). |
| 223 g | Sodium vinyl sulfonate (30% in deionized water). |
| 33.5 g | Sodium acetate (anhydrous) |
| 5.27 g | Sodium meta bisulfite |
| 0.0303 g | Mohr's Salt (Fe²⁺ Salt) |
| 1.59 g | Defoamer Agitan 282 |

The polyvinyl alcohol (29%) is dissolved in the deionized water at 90° C. for 2 hours. The reactor is purged with nitrogen to eliminate oxygen. Out of a total amount of 11590 g of vinyl acetate, 25% of the vinyl acetate is added to the water phase in the reactor. The ethylene valve is opened and the reactor is pressurized to 30 bar at ambient temperature (ca. 59% of ethylene stage 1 at 25° C.) and is then dosed again (total amount of ethylene: 1580 g). The reactor temperature is ramped up to 80° C. At 80° C. (the start temperature of the polymerization phase), the initiator feed, which is sodium peroxodisulfate (19.4 g in 817 g of deionized water), is added (over 3-4 min at a rate of approx. 970 g/h) into the reactor till the reaction is started. At 85° C., the rest of the vinyl acetate (75%) together with 65.9 g of glycidyl methacrylate is fed over 50 min into the reactor. At the same temperature (85° C.) the ethylene valve is opened again and the rest of the ethylene (41%) is feed into the reactor over approx. 10 min at maximum pressure of 67 bar at 105° C. The polymerization temperature is kept at approx. 110° C. by controlling the initiator rate. When the monomer feed (VAM) is completed, the initiator rate is increased to a maximum rate of 1200 g/h and the jacket temperature is kept at 95° C. till the reactor temperature is decreasing by reaction slow down. After the initiator feed is finished (the end of the polymerization phase, at a temperature of 100° C.), the reaction temperature is maintained at 85° C. for 30 min. The reactor is then cooled down to approximately 40° C. and the batch is released. A final redox treatment is made at this point by introducing Brüggolit FF 6 (a sodium salt of a sulfinic acid derivative, obtained from L. Brueggemann KG) (13 g in 126 g of deionized water) and afterwards Trigonox AW 70 (28 g). The product is stirred for 30 min before discharge.

TABLE 1
Process parameters for examples A-1 to A-3

| | | | | | Monomer |
|---|---|---|---|---|---|
| | | | | | addition |
| | | | | | during |
| | | | | Duration of | temperature |
| | | | | temperature | increase |
| | Start | End | | increase | based on |
| | temperature of | temperature of | Duration of | during | total |
| | polymerization | polymerization | polymerization | polymerization | monomers |
| Example | phase [° C.] | phase [° C.] | phase [min] | phase [%] | [%] |
| A-1 | 60 | 115 | 85 | 75.3 | 84.5 |
| A-2 | 60 | 120 | 85 | 76.5 | 84.5 |
| A-3 | 80 | 100 | 75 | 10.7 | 15.5 |
| (comp) | | | | | |

TABLE 2
Properties of the VAE copolymer dispersion obtained in
Examples A-1 to A-3

| | Example | | |
|---|---|---|---|
| | A-1 | A-2 | A-3 (comp) |
| Solids content [%] | 52.9 | 52.2 | 52.6 |
| pH | 4.4 | 4.4 | 4.2 |
| Brookfield Viscosity η (25° C., | 900 | 2800 | 1200 |
| Spindle 2, 20 rpm) [mPas] | | | |
| Residual vinyl acetate [%] | <0.1 | <0.1 | <0.1 |
| Tg (10 K/min, mid point) [° C.] | 10 | 10 | 11 |
| Particle size distribution (LAS) | 169 | 169 | 180 |
| dw [nm] | | | |
| dw/dn | 1.2 | 1.2 | 1.2 |
| K-Value in NMP, 1%, 23° C. | 59.1 | 58.9 | 49.0 |

According to Table 2, the K-value which is a measure for the molecular weight of a polymer shows high values for the inventive process compared to the polymerization process at a constant high temperature at the same monomer slow addition time. Higher K-values lead to better wet scrub resistance, better cohesion and heat resistance.

### Example B

### Example B-1 (Comparative)

### VAE-Based Copolymer Dispersion Preparation

Into a pressure reactor fitted with an anchor stirrer (running at 150 rpm), a heating jacket, dosage pumps and having a volume of 70 liters, a water based solution of the following components is added:

| | | |
|---|---|---|
| 25934 | g | Water (deionized) |
| 1478 | g | C 11 Alkyl polyglycol ether (28 mols of Ethylene Oxide)- |
| | | nonionic emulsifier (70% in deionized water). |
| 1154 | g | Sodium dodecylsulfate (15% in deionized water) |
| 591 | g | Sodium vinyl sulfonate (30% in deionized water) |
| 88.6 | g | Sodium acetate (anhydrous) |
| 14.1 | g | Sodium meta bisulfite |
| 0.081 | g | Mohr's Salt (Fe²⁺ Salt) |
| 4.24 | g | Defoamer Agitan 282 |

The reactor is purged with nitrogen to eliminate oxygen. Out of a total amount of 31014 g of vinyl acetate, 5% of the vinyl acetate is added to the water phase in the reactor. The ethylene valve is opened and the reactor is pressurized to 36 bar at ambient temperature (ca. 60% of ethylene stage 1 at 25° C.) and is then dosed again (total amount of ethylene: 4299 g). The reactor temperature is ramped up to 65° C. At 60° C. (the start temperature of the polymerization reaction phase), the initiator feed, which is sodium peroxodisulfate (115 g in 1236 g of deionized water), is added (initiator 1: 33.3% over 135 min) into the reactor. At 65° C. the rest of the vinyl acetate (95%) is fed over 242 min into the reactor. At the same temperature (65° C.) the ethylene valve is opened again and the rest of the ethylene (40%) is feed into the reactor over approx. 150 min at maximum pressure of 36 bar at 65° C. When the addition of initiator 1 is completed, immediately initiator 2 is continued (33.3% over 90 min). After the addition of initiator 2 is completed, initiator 3 is continued (33.4% over 60 min). 29 min before the vinyl acetate feed is stopped, the reactor temperature is raised to 85° C. 29 min and is maintained there for 60 min (after 28 min at that temperature, the initiator feed is completed (the end of the polymerization reaction phase)). The reactor is then cooled down to approximately 40° C. and the batch is released. A final redox treatment is made at this point by introducing Brüggolit FF 6 (a sodium salt of a sulfinic acid derivative, obtained from L. Brueggemann KG) (26 g in 250 g of deionized water) and afterwards Trigonox AW 70 (60 g). The product is stirred for 30 min before discharge.

### Example B-2

### VAE-Based Copolymer Dispersion Preparation

Into a pressure reactor fitted with an anchor stirrer (running at 150 rpm), a heating jacket, dosage pumps and having a volume of 70 liters, a water based solution of the following components is added:

| | | |
|---|---|---|
| 25934 | g | Water (deionized) |
| 1478 | g | C 11 Alkyl polyglycol ether (28 mols of Ethylene Oxide)- |
| | | nonionic emulsifier (70% in deionized water). |
| 1154 | g | Sodium dodecylsulfate (15% in deionized water) |
| 591 | g | Sodium vinyl sulfonate (30% in deionized water) |
| 88.6 | g | Sodium acetate (anhydrous) |
| 14.1 | g | Sodium meta bisulfite |
| 0.081 | g | Mohr's Salt (Fe 2+ Salt) |
| 4.24 | g | Defoamer Agitan 282 |

The reactor is purged with nitrogen to eliminate oxygen. Out of a total amount of 31014 g of vinyl acetate, 40% of the vinyl acetate is added to the water phase in the reactor. The reactor temperature is raised to 50° C. The ethylene valve is opened and the reactor is pressurized to 45 bar at 50° C. (100% of ethylene) and is then closed again (total amount of ethylene: 4299 g). The Initiator I, which is sodium peroxodisulfate (78 g in 618 g of deionized water), is added at 30° C. (the start of the polymerization reaction phase) into the reactor within 10 min. At 50° C. and exothermic behavior, the monomer feed (60% of the vinyl acetate) is fed over 118 min into the reactor. At the same time (50° C. reactor temperature) the temperature increase is started from 50 to 85° C. within 62 min. After that the reactor temperature is kept for another 56 min at 85° C. After 90 min (after vinyl acetate feed start) the initiator II solution, which is sodium peroxodisulfate (37 g in 618 g of deionized water), is added within 28 min. After all feeds (vinyl acetate and initiator II solution) are finished (the end of the polymerization reaction phase), the reactor temperature is maintained for another 60 min at 85° C. The reactor is then cooled down to approximately 40° C. and the batch is released. A final redox treatment is made at this point by introducing Brüggolit FF 6 (a sodium salt of a sulfinic acid derivative, obtained from L. Brueggemann KG) (26 g in 250 g of deionized water) and afterwards Trigonox AW 70 (60 g). The product is stirred for 30 min before discharge.

TABLE 3
Process parameters for examples B-1 and B-2

| | | | | | Monomer |
|---|---|---|---|---|---|
| | | | | Duration of | addition |
| | | | | temperature | during |
| | Start | End | | increase | temperature |
| | temperature | temperature of | Duration of | during | increase based |
| | polymerization | polymerization | polymerization | polymerization | on total |
| Example | phase [° C.] | phase [° C.] | phase [min] | phase [%] | monomers [%] |
| B-1 | 60 | 85 | 285 | 15.4 | 9.1 |
| (comp) | | | | | |
| B-2 | 30 | 85 | 160 | 65.0 | 26.4 |

Preparation of the FLAT Paint (51 PVC) (see Table 3 of US 2010/0056696).

Binder content (Dispersion): 29%

TABLE 4

| | Concentration | |
|---|---|---|
| | in water (%) | pbw [g] |
| Water | 0 | 130 |
| Propylene glycol | 0 | 13.7 |
| Natrosol Plus 330 PA | 100 | 0.8 |
| Tamol 1124 | 50 | 7.8 |
| Triton CF 10 | 100 | 2.8 |
| Rhodoline 643 | 100 | 3.5 |
| AMP 95 | 95 | 1.0 |
| Tronox CR 828 | 100 | 156 |
| ASP NC | 100 | 78 |
| Celite 281 | 100 | 35 |
| Omyacarb 3 | 100 | 125 |
| Attagel 40 | 100 | 1.6 |
| Bermodol PUR 2110 | 30 | 9.8 |
| Texanol | 0 | 2.7 |
| Water | 0 | 27.1 |
| Pigment paste | | 595.7 |
| Dispersion | 55 | 264.3 |
| Water | 0 | 140 |
| Pigment paste | 69.1 | 595.7 |
| Total | | 1000.0 |
| solids content % | | 55.7 |
| pvc % | | 49.9 |

Scub resistance test ASTM D2486 of the FLAT Paint (51 PVC) according to US 2010/0056696, paragraph [0158].

TABLE 5
Results of the comparative and the inventive VAE copolymer dispersion

Example

| | B-1 (comp) | B-2 |
|---|---|---|
| Solids content [%] | 55.4 | 55.7 |
| pH | 4.7 | 4.8 |
| Brookfield Viscosity η (25° C., | 960 | 348 |
| Spindle 2, 20 rpm) [mPas] | | |
| Residual vinyl acetate [ppm] | 950 | 1030 |
| Tg (10 K/min, mid point) [° C.] | 13 | 13 |
| Particle size distribution (LAS) | 160 | 183 |
| dw [nm] | | |
| dw/dn | 1.2 | 1.3 |
| K-Value in NMP, 1%, 23° C. | 59 | 92 |
| Wet scrub resistance ASTM | 260 | 372 |
| D2486 [cycles] | | |

Example B-2 according to the present invention shows a higher K-value and better wet scrub resistance in flat paints compared to Comparative Example B-1 at even significant shorter polymerization times.

### Example C

### Examples C-1 to C-5 (Comparative)

### Preparation of the VAE-based Copolymer Dispersion at constant polymerization temperature

Into a pressure reactor fitted with anchor stirrer (running at 220 rpm), a heating jacket, dosage pumps, a DCS (distributed control system) for control of the additions and the reactor temperature and having a volume of 29.2 liters, the following components are added:

| | | |
|---|---|---|
| 10168 | g | Water (deionized) |
| 672 | g | Alkyl polyglycol ether (C11 Alkyl-30 mols of ethylene |
| | | oxide, conc. 65%) |
| 376 | g | Alkyl benzene sulfonate (conc. 20%) |
| 251 | g | Sodium vinyl sulfonate (30%) |
| 37.6 | g | Sodium acetate (anhydrous) |
| 3.01 | g | Brueggolite FF6 |
| 0.62 | g | Mohr's Salt |
| 1.51 | g | EDTA tetra sodium salt |
| 6.17 | g | Agitan 282 |

The reactor is purged with nitrogen to eliminate oxygen. Out of a total amount of 13185 g vinyl acetate, an initial amount of vinyl acetate is added to the water phase in the reactor. The ethylene valve is opened and the reactor is pressurized with 840 g of ethylene. In parallel 10% of a solution (reducer solution) of 12.0 g of Brueggolite FF6 in 557 g of deionized water are added to the reactor, the reactor temperature is ramped up to 45° C. and the system is allowed to equilibrate. To start and maintain the reaction 71% of the above solution of Brueggolite FF6 in water and 77% of a solution (oxidizer solution) of 30.1 g of sodium persulphate in 557 g of deionized water are added to the reactor in parallel and over a period of 210 min (start of the polymerization reaction phase). Once the reactor temperature has reached a temperature of 50° C. (Examples C-1 and C-4), 85° C. (Examples C-2 and C-5) and 67.5° C. (Example C-3), respectively, the monomer additions are started. For this the remaining vinyl acetate is mixed with 75.26 g of vinyl trimethoxysilane and is added to the reactor within 200 min. At the same time 1026 g of ethylene are added to the reactor. For the ethylene addition the reactor pressure is fixed to 30 bars via an automatic control valve. Once the full amount of ethylene is in the valve is closed and the reactor pressure is allowed to drop until the reaction is finished.

Once the above amounts of monomer, ethylene, oxidizer and reducer have been added to the reactor, a polymerization period follows where the remaining amounts of the oxidizer and reducer solutions are added over a period of 40 minutes. After completion of this initiator feed, the end of the polymerization reaction phase is reached. During this period the reactor temperature is raised to or kept at 85° C. (the end temperature) via the reactor jacket. The process parameters of examples C-1 to C-5 are summarized in Table 6. The deviation of the duration of the polymerization phase as given in table 6 and the description above is for C-1-C-5 due to deviations in real pump speed from setpoints in DCS. For all examples the 210 min and 40 min described above were used as DCS setpoints for the duration of the initiator feeds. Characteristics of the emulsion are summarized in Table 7.

### Examples C-6 to C-8

Preparation of the VAE-based Copolymer Dispersion using a temperature ramp: Into a pressure reactor fitted with anchor stirrer (running at 220 rpm), a heating jacket, dosage pumps, a DCS for control of the additions and the reactor temperature and having a volume of 29.2 liters, the following components are added:

| | | |
|---|---|---|
| 10168 | g | Water (deionized) |
| 672 | g | Alkyl polyglycol ether (C11 Alkyl-30 mols of ethylene |
| | | oxide, conc. 65%) |
| 376 | g | Alkyl benzene sulfonate (conc. 20%) |
| 251 | g | Sodium vinyl sulfonate (30%) |
| 37.6 | g | Sodium acetate (anhydrous) |
| 3.01 | g | Brueggolite FF6 |
| 0.62 | g | Mohr's Salt |
| 1.51 | g | EDTA tetra sodium salt |
| 6.17 | g | Agitan 282 |

The reactor is purged with nitrogen to eliminate oxygen. Out of a total amount of 13185 g vinyl acetate, an initial amount of vinyl acetate is added to the water phase in the reactor. The ethylene valve is opened and the reactor is pressurized with 840 g of ethylene. In parallel 10% of a solution (reducer solution) of 12.0 g of Brueggolite FF6 in 557 g of deionized water are added to the reactor, the reactor temperature is ramped up to 45° C. and the system is allowed to equilibrate. To start and maintain the reaction 71% of the above solution of Brueggolite FF6 in water and 77% of a solution (oxidizer solution) of 30.1 g of sodium persulfate in 557 g of deionized water are added to the reactor in parallel and over a period of 210 min (start of the polymerization reaction phase). Once the reactor temperature has reached the starting temperature of the temperature increase (Example C-6: 50° C., Example C-7: 67.5° C., Example C-8: 50° C.), the monomer additions are started. For this the remaining vinyl acetate is mixed with 75.26 g of vinyl trimethoxysilane and is added to the reactor within 200 min. At the same time 1026 g of ethylene are added to the reactor. For the ethylene addition the reactor pressure is fixed to 30 bars via an automatic control valve. Once the full amount of ethylene has been added, the valve is closed and the reactor pressure is allowed to drop until the reaction is finished. While the vinyl acetate/vinyl trimethoxysilane mixture is added to the reactor, the reaction temperature is allowed to rise from the starting temperature of the temperature increase to 85° C. Once the above amounts of monomer, ethylene, oxidizer and reducer have been added to the reactor, a polymerization period follows where the remaining amounts of the oxidizer and reducer solutions are added over a period of 40 minutes. After completion of this initiator feed, the end of the polymerization reaction phase is reached. During this period the reactor temperature is raised to or kept at 85° C. (the end temperature). The process parameters of examples C-6 to C-8 are summarized in Table 6. C-8 had a 15 min stop in the initator feed between the initial 210 min addition period and the following 40 min period. For all examples the 210 min and 40 min described above were used as DCS setpoints for the duration of the initiator feeds. Characteristics of the emulsion are summarized in Table 7.

TABLE 6
Process parameters for examples C-1 to C-8

| | | | | | Monomer |
|---|---|---|---|---|---|
| | | | | Duration of | addition |
| | | | | temperature | during |
| | Start | End | | increase | temperature |
| | temperature of | temperature of | Duration of | during | increase based |
| | polymerization | polymerization | polymerization | polymerization | on total |
| Example | phase [° C.] | phase [° C.] | phase [min] | phase [%] | monomers [%] |
| C-1 | 45 | 85 | 250 | 10.8 | 3.7 |
| (comp) | | | | | |
| C-2 | 45 | 85 | 249 | 8.0 | 13.4 |
| (comp) | | | | | |
| C-3 | 45 | 85 | 249 | 12.4 | 0.2 |
| (comp) | | | | | |
| C-4 | 45 | 85 | 255 | 5.9 | 0 |
| (comp) | | | | | |
| C-5 | 45 | 85 | 250 | 4.0 | 0.6 |
| (comp) | | | | | |
| C-6 | 45 | 85 | 250 | 84.0 | 89.4 |
| C-7 | 45 | 85 | 250 | 82.8 | 66.9 |
| C-8 | 45 | 85 | 265 | 72.5 | 44.4 |

TABLE 7
Characteristics of the emulsions of examples C-1 to C-8

| | Example | | | | | | | |
|---|---|---|---|---|---|---|---|---|
| | C-1 | C-2 | C-3 | C-4 | C-5 | C-6 | C-7 | C-8 |
| Solids | 55.7 | 54.7 | 55 | 54.6 | 54.9 | 55.1 | 54.9 | 55.3 |
| content | | | | | | | | |
| [%] | | | | | | | | |
| pH | 4.8 | 4.4 | 4.9 | 5.1 | 4.4 | 4.8 | 4.8 | 4.8 |
| Brookfield | 1600, | 452, | 770, | 446, | 346, | 55, | 300, | 400, |
| Viscosity η (20° C.) | 2, | 2, 20 | 3, 20 | 2, 20 | 2, 20 | 3, 20 | 3, 20 | 3, 20 |
| [mPas; | 20 | | | | | | | |
| spindle, rpm] | | | | | | | | |
| Particle size | 0.16 | 0.18 | 0.17 | 0.18 | 0.20 | 0.18 | 0.21 | 0.19 |
| distribution | | | | | | | | |
| (BW) dw [nm] | | | | | | | | |
| dw/dn | 1.2 | 1.2 | 1.3 | 1.2 | 1.2 | 1.3 | 1.2 | 1.2 |
| K-Value in | 72 | 56 | 89 | 106 | 83 | 71 | 97 | 111 |
| NMP, 1%, | | | | | | | | |
| 23° C. | | | | | | | | |

The polymers obtained from the polymerization reactions using a process with temperature increase according to above examples C-6 to C-8 show a significantly higher K-value compared to products obtained from polymerizations carried out at higher temperatures according to examples C-1 to C-8 (50 & 67.5° C. vs. 85° C.; 50° C. vs. 67.5° C. and 67.5° C. VS. 85° C.).

### Example D

### Example D-1 (Comparative)

### VAE-Based Copolymer Dispersion Preparation

Into a pressure reactor fitted with an anchor stirrer (running at iso rpm), a heating jacket, is dosage pumps and having a volume of 30 liters, a water based solution of the following components is added:

| | | |
|---|---|---|
| 10322 | g | Water (deionized) |
| 173 | g | Polyvinyl alcohol solution (15%) in deionized water, i.e., |
| | | partially hydrolyzed [88 hydrolysis (mole %)] that forms a |
| | | 4% solution viscosity of 4.50 cP ± 0.50 at 20° C. |
| 557 | g | C11 Alkyl polyglycol ether (28 mols of Ethylene Oxide)- |
| | | nonionic emulsifier (70% in deionized water). |
| 234 | g | sodium dodecyl sulfate (15%) |
| 223 | g | Sodium vinylsulfonate (30% in deionized water) |
| 32 | g | Sodium acetate (anhydrous) |
| 5.1 | g | Sodium meta bisulfite |
| 0.03 | g | Mohr's Salt (Fe²⁺ Salt) |

The reactor is purged with nitrogen to eliminate oxygen. Out of a total amount of 11908 g of monomer mix consisting of 11856 g vinyl acetate and 52 g vinyl trimethoxysilane, 29% of the mix is added to the water phase in the reactor. The ethylene valve is opened and the reactor is pressurized with 149 g of ethylene (13% of total ethylene) and is then closed again (total amount of ethylene: 1144 g).

The reactor temperature is ramped up to 40° C. At that temperature, the initiator feed, which is sodium peroxodisulfate (40 g in 715 g of deionized water), is started to run in over 245 min at a rate of approx. 190 g/h (the start of the polymerization reaction phase). The start of polymerization is clearly visible by a temperature rise which is continued to 65° C. within 25 min. Reaching 65° C., the addition of the remaining monomer mix is started in 2 phases: 1. 3.5% of the monomer mix are added in 20 min, 2. the remaining 67.5% are added within another 200 min. With the start of the second phase, the remaining ethylene (995 g, 87%) is added over 60 min (reaching a max. pressure of ca. 48 bar). 30 min before the liquid monomer addition is finished (80% of total liquid monomer added) the temperature is increased from 65° C. to 85° C. (the end temperature) within 30 min, so the final temperature is reached with end of additions (monomer mix and initiator); i.e. at the end of the polymerization reaction phase. The reactor is kept at 85° C. for another 60 min and then cooled down to approximately 40° C. and the batch is released.

### Example D-2

### VAE-Based Copolymer Dispersion Preparation

Into a pressure reactor fitted with an anchor stirrer (running at 150 rpm), a heating jacket, dosage pumps and having a volume of 30 liters, a water based solution of the following components is added:

| | | |
|---|---|---|
| 10322 | g | Water (deionized) |
| 173 | g | Polyvinyl alcohol solution (15%) in deionized water, i.e., |
| | | partially hydrolyzed [88 hydrolysis (mole %)] that forms a |
| | | 4% solution viscosity of 4.50 cP ± 0.50 at 20° C. |
| 557 | g | C11 Alkyl polyglycol ether (28 mols of Ethylene Oxide)- |
| | | nonionic emulsifier (70% in deionized water) |
| 443 | g | sodium dodecyl sulfate (15%) |
| 223 | g | Sodium vinylsulfonate (30% in deionized water) |
| 32 | g | Sodium acetate (anhydrous) |
| 5.1 | g | Sodium meta bisulfite |
| 0.03 | g | Mohr's Salt (Fe²⁺ Salt) |

The reactor is purged with nitrogen to eliminate oxygen. Out of a total amount of 11908 g of monomer mix consisting of 11856 g vinyl acetate and 52 g vinyl trimethoxysilane, 29% of the mix is added to the water phase in the reactor. The ethylene valve is opened and the reactor is pressurized with 149 g of ethylene (13% of total ethylene) and is then closed again (total amount of ethylene: 1144 g).

The reactor temperature is ramped up to 40° C. (the start temperature). At that temperature, the initiator feed, which is sodium peroxodisulfate (40 g in 715 g of deionized water), is started to run in over 210 min at a rate of approx. 215 g/h (the start of the polymerization reaction phase). The start of polymerization is clearly visible by a temperature rise which is continued to 65° C. within 43 min. Reaching 65° C., the addition of the remaining monomer mix is started in several phases: 1. 3.5% of the monomer mix are added in 20 min (1250 g/h), 2. 20% are added (2380 g/h) together with the remaining ethylene (995 g Ethylene, 87%) over 62 min (reaching a max. pressure of ca. 48 bar), 3. after finalizing the ethylene addition further 28.5% of the monomer mix is added in 57 min. During that period the temperature is slowly ramped up from 65° C. to 75° C. 4. With the final 19% of the monomer mix the temperature is then further increased from 75° C. to 90° C. within 28 min, so the final temperature (at the end of the polymerization reaction phase) is reached with end of additions (monomer mix and initiator). The reactor is kept at 90° C. for another 60 min and then cooled down to approximately 40° C. and the batch is released.

### Example D-3

### VAE-Based Copolymer Dispersion Preparation

Into a pressure reactor fitted with an anchor stirrer (running at 150 rpm), a heating jacket, dosage pumps and having a volume of 30 liters, a water based solution of the following components is added:

| | | |
|---|---|---|
| 10322 | g | Water (deionized) |
| 173 | g | Polyvinyl alcohol solution (15%) in deionized water, i.e., |
| | | partially hydrolyzed [88 hydrolysis (mole %)] that forms a |
| | | 4% solution viscosity of 4.50 cP ± 0.50 at 20° C. |
| 557 | g | C11 Alkyl polyglycol ether (28 mols of Ethylene Oxide)- |
| | | nonionic emulsifier (70% in deionized water) |
| 433 | g | sodium dodecyl sulfate (15%) |
| 223 | g | Sodium vinylsulfonate (30% in deionized water). |
| 32 | g | Sodium acetate (anhydrous) |
| 5.1 | g | Sodium meta bisulfite |
| 0.03 | g | Mohr's Salt (Fe²⁺ Salt) |

The reactor is purged with nitrogen to eliminate oxygen. Out of a total amount of 11908 g of monomer mix consisting of 11856 g vinyl acetate and 52 g vinyl trimethoxysilane, 32.5% of the mix is added to the water phase in the reactor. The ethylene valve is opened and the reactor is pressurized with 149 g of Ethylene (13% of total ethylene) and is then closed again (total amount of ethylene: 1144 g).

The reactor temperature is ramped up to 40° C. At that temperature, the initiator feed, which is sodium peroxodisulfate (40 g in 715 g of deionized water), is started to run in over 185 min at a rate of approx. 245 g/h (the start of the polymerization reaction phase). The start of polymerization is clearly visible by a temperature rise which is continued to 65° C. within 35 min. Reaching 65° C., the addition of the remaining monomer mix is started in 2 phases: 1. 48.5% are added within 120 min (2380 g/h) and in the same time the reaction temperature is slowly ramped up from 65° C. (start temperature) to 75° C. With the start of monomer addition, the remaining ethylene (995 g Ethylene, 87%) is also added (within 60 min, reaching a max. pressure of ca. 48 bar). 2. With the final 19% of the monomer mix the temperature is then further increased from 75° C. to 90° C. (the end temperature) within 30 min, so the final temperature (at the end of the polymerization reaction phase) is reached with end of additions (monomer mix and initiator). The reactor is kept at 90° C. for another 60 min and then cooled down to approximately 40° C. and the batch is released.

TABLE 8
Process parameters for examples D-1 to D-3:

| | | End | | | Monomer |
|---|---|---|---|---|---|
| | Start | temperature | | Duration of | addition during |
| | temperature | of | Duration of | temperature | temperature |
| | of | polymerization | polymerization | increase during | increase based |
| | polymerization | phase | phase | polymerization | on total |
| Example | phase [° C.] | [° C.] | [min] | phase [%] | monomers [%] |
| D-1 | 40 | 85 | 245 | 22.4 | 16.5 |
| (comp) | | | | | |
| D-2 | 40 | 90 | 210 | 61.0 | 43.3 |
| D-3 | 40 | 90 | 185 | 100 | 69.2 |

TABLE 9
Properties of the VAE copolymer dispersion
obtained in Examples D-1 to D-3

| | Example | | |
|---|---|---|---|
| | D-1 (comp) | D-2 | D-3 |
| Solids content [%] | 53.4 | 53.4 | 53.5 |
| pH | 4.9 | 5.2 | 5.0 |
| Brookfield Viscosity η (25 ° C., | 643 | 510 | 580 |
| Spindle 2, 20 rpm) [mPas] | | | |
| Residual vinyl acetate [%] | 0.2 | 0.2 | 0.2 |
| Tg (10 K/min, mid point) [° C.] | 17 | 16.5 | 17.5 |
| Particle size distribution (LAS) | 160 | 176 | 167 |
| dw [nm] | | | |
| dw/dn | 1.2 | 1.2 | 1.2 |

TABLE 10
Paint formulation for application testing

| | pbw [g] |
|---|---|
| Water | 195 |
| Hydroxyethyl cellulose (Hopper viscosity of | 4.5 |
| 2% aqu. Solution of 6,000 mPas) | |
| sodium polyphosphate (dispersing agent), | 3 |
| 10% | |
| Polyacrylate salt (dispersing agent), 40% | 3 |
| Defoamer | 6 |
| Titanium dioxide (pigment, ca. 300 nm) | 190 |
| Calcium Carbonate filler (0.9 μm) | 130 |
| NaOH solution, 10% | 3.5 |
| PU-Thickener | 4.5 |
| Pigment paste | 540 |
| Dispersion (adjusted with water to 50% | 460 |
| solids) | |
| Pigment paste | 540 |
| Total | 1000.0 |
| pvc % | 32.7 |

TABLE 11
application parameters satin paint 46% binder (composition see Table 10)

| | WSR-loss | | | | |
|---|---|---|---|---|---|
| | in μm ISO | Gloss | Paint | | K-Value of |
| | (7 d/28 d) | 60° | viscosity | Blocking | the emulsion |
| D-1 (comp) | 4/5 | 18.8 | 9500 | 1200 | 70 |
| D-2 | 5/6 | 21 | 8700 | 1500 | 69 |
| D-3 | 4/6 | 19.7 | 7700 | 1200 | 69 |

Accordingly, if a process using a temperature increase (starting at a lower temperature and ending at a higher temperature) is employed, the resulting products also exhibit the same or higher K-values compared to the products made at low temperatures. Higher K values typically can be interpreted in terms of higher molecular weight with the latter being beneficiary for many applications (see above).

In summary, the above experimental data show the advantageous effects of a polymerization process that is started at 30-85° C. and then ramped up continuously to 60-160° C. The higher the final maximum temperature can be, the shorter the process will be. According to Example A-1, the usual monomer feeding time could be reduced from 3.5 h to 1 h. It was surprisingly found that the K-value (indicator for the molecular weight) is significantly higher compared to a process at constant high temperature (Example A-3). Additionally a relative efficient post heating phase can be applied.

Example B-2 shows a process using a ramp process as described above, leading to monomer slow addition times of 120 min and K-values with about in units higher than achieved by standard processes as described in B-1.

Examples C-1 to C-8 demonstrate that polymers made via a ramped process, will have a similar or even higher K-value compared to the polymers made under constant temperature reaction conditions. Although for the present samples dosage times were not varied, reaction temperature increasing with time has potential for batch cycle time reductions. Parts of the heat of reaction will be consumed for the heating of the reaction mixture and at higher temperatures more heat can be removed if cooling water temperature remains constant.

Examples D1-D3 again show that using the ramp process results in comparable performance at a significantly reduced (−2 h) reaction time.

1. A process for the emulsion polymerization of free-radically polymerizable, ethylenically unsaturated main monomers, and optionally further auxiliary monomers copolymerizable therewith,
wherein the polymerization comprises a polymerization reaction phase starting with the first addition of an initiator or starting with the first addition of monomers, whatever is later, and ending with the completion of the addition of the initiator or the completion of the addition of total monomers, whatever is later,
wherein the reaction temperature is increased during said polymerization reaction phase from a start temperature in the range of about 30° C. to about 85° C. to an end temperature in the range of about 60° C. to about 160° C., and
wherein the polymerization temperature is increased for at least 25% of the duration of said polymerization reaction phase.

2. The process according to claim 1, wherein the temperature is increased continuously or semi-continuously.

3. The process according to claim 1, wherein up to 100% of the total monomers, based on the total amount of main monomers to be copolymerized, are initially charged prior to the first addition of the initiator, and the remainder is continuously added in the course of said polymerization reaction phase.

4. The process according to claim 1, wherein at least 25% of the total monomers, based on the total weight, are added during the temperature increase in the course of said polymerization reaction phase.

5. The process according to claim 1, wherein the polymerization temperature is increased for at least 50% of the duration of said polymerization reaction phase.

6. The process according to claim 1, wherein the start temperature is in a range of about 40° C. to about 80° C.

7. The process according to claim 1, wherein the end temperature is in a range of about 80° C. to about 120° C.

8. The process according to claim 1, wherein the temperature rate during the temperature increase is in the range of about 0.05° C./min to about 5° C./min.

9. The process according to claim 1, wherein the temperature increase comprises a period with a temperature rate of more than 0.05° C./min and less than 0.2° C./min, and a subsequent period with a temperature rate of 0.2° C./min to 0.7° C./min, and wherein at least 75% of the total monomers, based on the total weight, are added during the temperature increase in the course of said polymerization reaction phase.

10. The process according to claim 1, wherein the polymerization reaction is started by an initiator system consisting of one or more water-soluble free radical initiators.

11. The process according to claim 1, wherein the free-radically polymerizable, ethylenically unsaturated main monomers are selected from the group consisting of vinyl esters of C₁-C₁₈ alkanoic acids, vinyl esters of aromatic acids, vinyl aromatics, vinyl halogenides, α-olefins, dienes, monoesters and diesters of ethylenically unsaturated monocarboxylic or dicarboxylic acids with alkanols, and combinations thereof.

12. The process according to claim 11, wherein the vinyl ester is selected from the group consisting of vinyl esters of straight-chain or branched carboxylic acids with 1 to 18 carbon atoms and vinyl esters of aromatic acids, such as vinyl formate, vinyl acetate, vinyl propionate, vinyl butyrate, vinyl isobutyrate, vinyl pivalate, 1-methylvinyl acetate, vinyl 2-ethylhexanoate, vinyl laurate, vinyl palmitate, vinyl myristate, vinyl stearate, vinyl ester of an α-branched carboxylic acid having 5 to 11 carbon atoms, especially vinyl esters of Versatic acid having 9 to 11 carbon atoms, vinyl benzoate, 4-tert-butyl vinyl benzoate, and combinations thereof.

13. The process according to claim 1, wherein the auxiliary monomers are selected from the group consisting of ethylenically unsaturated mono- and dicarboxylic acids, ethylenically unsaturated sulfonic acids or their salts, ethylenically unsaturated carboxylic acid amides and nitriles, ethylenically unsaturated phosphonic acids or their salts, ethylenically unsaturated ethylene urea derivatives, ethylenically unsaturated 1,3-dicarbonyl compounds, ethylenically unsaturated hydroxyl group or epoxy group containing monomers, ethylenically unsaturated silane compounds, and combinations thereof.

14. The process according to claim 13, wherein the auxiliary monomer contains an ethylenically unsaturated silane compound selected from the group consisting of vinyl trimethoxysilane, vinyl triethoxysilane, vinyl tris-(1-methoxy) isopropoxy silane, methacryloxypropyl tris(2-methoxyethoxy)silane, 3-methacryloxypropyl trimethoxysilane, 3-methacryloxypropylmethyl dimethoxysilane, 3-methacryloxymethyl trimethoxysilane, and combinations thereof.

15. The process according to claim 13, wherein the auxiliary monomer contains an ethylenically unsaturated hydroxyl group or epoxy group containing monomer selected from the group consisting of hydroxyethyl methacrylate, glycidyl acrylate, glycidyl methacrylate, allyl glycidyl ether, vinyl glycidyl ether, hydroxypropyl acrylate, hydroxybutyl acrylate, hydroxyethyl acrylate, hydroxypropyl methacrylate, and combinations thereof.

16. The process according to claim 1, wherein a hydrolyzable silicon compound selected from the group consisting of hydrolyzable epoxy silanes, hydrolyzable amino silanes, hydrolyzable mercapto silanes, hydrolyzable alkoxy silane compounds having the formula (R⁶)ₙ—Si-(OR⁷)₄₋ₙ, wherein n is 0, 1, 2 or 3, and R⁶ and R⁷ are each independently a straight-chain or branched C₁-C₁₆ alkyl, and combinations thereof, is additionally added before, during or after the polymerization reaction phase.

17. The process according to claim 16, wherein the hydrolyzable silicon compound is selected from the group consisting of 3-glycidoxypropyl trimethoxysilane, 3-glycidoxypropyl triethoxysilane, 3-(2-aminoethylamino)propyl trimethoxysilane, 3-mercaptopropyl trimethoxysilane, tetraethoxysilane, methyltriethoxysilane, hexyltriethoxysilane, and combinations thereof.

18. The process according to claim 1, wherein vinyl acetate and one or more further main monomers and/or one or more auxiliary monomers are copolymerized.

19. The process according to claim 18, wherein 50 to 99% of vinyl acetate, 1 to 40% of ethylene, and optionally up to 30% of one or more further main monomers and/or up to 10% of one or more auxiliary monomers are copolymerized.

20. The process according to claim 19, wherein a copolymer is prepared from a mixture comprising 1 to 40% by weight, based on total monomers, of ethylene, 59.9 to 98.9% by weight, based on total monomers, of vinyl acetate, 0.05 to 5% by weight, based on total monomers, of an ethylenically unsaturated epoxy group containing monomer, 0.05 to 5% by weight, based on total monomers, of a hydrolyzable ethylenically unsaturated silane compound, and 0 to 20% by weight, based on total monomers, of one or more further main or auxiliary monomers.

21. The process according to claim 19 or 20, wherein the further main monomer is selected from the group consisting of methyl acrylate, methyl methacrylate, 2-ethylhexyl acrylate, butyl acrylate, vinyl propionate, vinyl laurate, vinyl palmitate, vinyl myristate, vinyl pivalate, vinyl 2-ethylhexanoate, and vinyl esters of an α-branched carboxylic acid having 5 to 11 carbon atoms, especially vinyl esters of Versatic acid having 9 to 11 carbon atoms, and combinations thereof.

22. The process according to claim 1, wherein styrene, acrylic acid, and optionally one or more further main monomers and/or one or more auxiliary monomers are copolymerized.

23. A process for the emulsion polymerization of free-radically polymerizable, ethylenically unsaturated main monomers, and optionally further auxiliary monomers copolymerizable therewith, to prepare a polymer having low residual monomer content, the process comprising:
the process according to claim 1, and subsequently
a post-polymerization reaction.

24. An aqueous (co)polymer dispersion comprising at least one (co)polymer formed by the processes according to claim 1.

25. Use of the aqueous (co)polymer dispersion according to claim 24 as a binder in paints, paper saturation and paper coating, adhesives, nonwovens, textiles, carpet back-coatings, construction, or powder.
